(19) United States
(12) Patent Application Publication
(10) Pub. No.: US 2016/0180431 A1
(43) Pub. Date: Jun. 23, 2016

(54) SYSTEM TO COMMUNICATE CONSUMER PRODUCT INFORMATION TO A CONSUMER AND RELATED METHODS

(71) Applicant: Wal-Mart Stores, Inc., Bentonville, AR (US)

(72) Inventor: Mahesh Mohan Thakur, San Jose, CA (US)

(73) Assignee: WAL-MART STORES, INC., Bentonville, AR (US)

(21) Appl. No.: 14/579,731

(22) Filed: Dec. 22, 2014

(51) Int. Cl. G06Q 30/06

(52) U.S. Cl. CPC G06Q 30/0625

(57) ABSTRACT

Some embodiments include a method. The method can include identifying consumer product locations of multiple consumer products, determining a consumer health code based on health profile information of a consumer, and determining consumer product information to communicate to the consumer. Determining consumer product information to communicate to the consumer can include identifying a consumer location of the consumer and determining the consumer product information based on at least (i) the consumer health code and (ii) the consumer location relative to at least two of the consumer product locations. The method further can include communicating to the consumer the consumer product information. Other embodiments of related methods and systems are also provided.

### TECHNICAL FIELD

This disclosure relates generally to systems to communicate consumer product information to a consumer, and relates more particularly to systems to communicate the consumer product information to the consumer based on health profile information of the consumer and/or one or more consumer affiliated entities and a location of the consumer and to related methods.

### BACKGROUND

When purchasing consumer products, a consumer may have numerous options from which to choose without having adequate or any information available to make informed (e.g., educated) decisions about her purchases. These situations can be problematic for the consumer, particularly when the consumer products can affect her health and well being. For example, the consumer may be unaware whether certain foods are unhealthy, whether her medications will react adversely with each other, whether certain consumer products may be of a higher quality or a lower cost, etc. Accordingly, there is a need for systems and methods to better educate consumers about their purchases.

### BRIEF DESCRIPTION OF THE DRAWINGS

To facilitate further description of the embodiments, the following drawings are provided in which:

FIG. 1 illustrates a front elevational view of an exemplary computer system that is suitable to implement at least part of a central computer system and/or at least part of one or more consumer computer systems of the system of FIG. 3 and/or to implement at least part of one or more of the activities of FIGS. 6-25;

FIG. 2 illustrates a representative block diagram of exemplary elements included on the circuit boards inside a chassis of the computer system of FIG. 1;

FIG. 3 illustrates a representative block diagram of a system, according to an embodiment;

FIG. 4 illustrates a representative block diagram of a central computer system of the system of FIG. 3, according to the embodiment of FIG. 3;

FIG. 5 illustrates a representative block diagram of one or more databases of the system of FIG. 3, according to the embodiment of FIG. 3;

FIG. 6 illustrates a flow chart for a method, according to an embodiment;

FIG. 7 illustrates an exemplary activity of identifying consumer product locations of multiple consumer products, according to the embodiment of FIG. 6;

FIG. 8 illustrates an exemplary activity of determining consumer product information to communicate to a consumer, according to the embodiment of FIG. 6;

FIG. 9 illustrates an exemplary activity of identifying a selection of a consumer product by the consumer, according to the embodiment of FIG. 6;

FIG. 10 illustrates an exemplary activity of communicating the consumer product information to the consumer, according to the embodiment of FIG. 6;

FIG. 11 illustrates a flow chart for a method, according to an embodiment;

FIG. 12 illustrates an exemplary activity of determining consumer product information to communicate to a consumer, according to the embodiment of FIG. 11;

FIG. 13 illustrates an exemplary activity of identifying a selection of a consumer product by the consumer, according to the embodiment of FIG. 11;

FIG. 14 illustrates an exemplary activity of identifying a consumer location of the consumer, according to the embodiment of FIG. 11;

FIG. 15 illustrates an exemplary activity of communicating the consumer product information to the consumer, according to the embodiment of FIG. 11;

FIG. 16 illustrates a flow chart for a method, according to an embodiment;

FIG. 17 illustrates an exemplary activity of identifying consumer product locations of multiple consumer products, according to the embodiment of FIG. 16;

FIG. 18 illustrates an exemplary activity of determining consumer product information to communicate to the consumer, according to the embodiment of FIG. 16;

FIG. 19 illustrates an exemplary activity of communicating the consumer product information to the consumer, according to the embodiment of FIG. 16;

FIG. 20 illustrates an exemplary activity of identifying a selection of a consumer product by the consumer, according to the embodiment of FIG. 16;

FIG. 21 illustrates a flow chart for a method, according to an embodiment;

FIG. 22 illustrates an exemplary activity of determining consumer product information to communicate to the consumer, according to the embodiment of FIG. 21;

FIG. 23 illustrates an exemplary activity of identifying a consumer location of the consumer, according to the embodiment of FIG. 21;

FIG. 24 illustrates an exemplary activity of communicating the consumer product information to the consumer, according to the embodiment of FIGS. 21; and

FIG. 25 illustrates an exemplary activity of identifying a selection of a consumer product by the consumer, according to the embodiment of FIG. 21.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

Some embodiments include a method. The method can comprise: executing one or more first computer instructions configured to identify consumer product locations of multiple consumer products; and executing one or more second computer instructions configured to determine consumer product information to communicate to a consumer. Executing the one or more second computer instructions can comprise: executing one or more third computer instructions configured to identify a selection of a consumer product by the consumer, the multiple consumer products including the consumer product; and responsive to the executing the one or more third computer instructions: executing one or more fourth computer instructions configured to identify a consumer location of the consumer; and executing one or more fifth computer instructions configured to determine the consumer product information for the consumer product selected by the consumer based on at least (i) at least one of health profile information of the consumer or health profile information of a consumer affiliated entity of the consumer and (ii) the consumer location relative to at least two of the consumer product locations. The method further can comprise executing one or more sixth computer instructions configured to communicate to the consumer the consumer product information for the consumer product selected by the consumer. The one or more first computer instructions, the one or more second computer instructions, the one or more third computer instructions, the one or more fourth computer instructions, the one or more fifth computer instructions, and the one or more sixth computer instructions can be configured to run at one or more processing modules and configured to be stored at one or more non-transitory memory storage modules.

Other embodiments include a system. The system comprises an input device, a display device, one or more processing modules, and one or more non-transitory memory storage modules storing computer instructions configured to run on the one or more processing modules and perform multiple acts. The multiple acts can include: identifying consumer product locations of multiple consumer products; and determining consumer product information to communicate to a consumer. Determining the consumer product information to communicate to the consumer can comprise: identifying a selection of a consumer product by the consumer, the multiple consumer products including the consumer product; and responsive to the identifying the selection of the consumer product by the consumer: identifying a consumer location of the consumer; and determining the consumer product information for the consumer product selected by the consumer based on at least (i) at least one of health profile information of the consumer or health profile information of a consumer affiliated entity of the consumer and (ii) the consumer location relative to at least two of the consumer product locations. Further, the multiple acts also can include communicating to the consumer the consumer product information for the consumer product selected by the consumer. Meanwhile, the input device and the display device can be configured to permit an operator of the one or more processing modules and the one or more non-transitory memory storage modules to manage the one or more processing modules and the one or more non-transitory memory storage modules.

Further embodiments include at least one non-transitory memory storage module having computer instructions stored thereon executable by one or more processing modules to: (a) identify consumer product locations of multiple consumer products; (b) determine consumer product information to communicate to a consumer by: identifying a selection of a consumer product by the consumer, the multiple consumer products including the consumer product; and responsive to the identifying the selection of the consumer product by the consumer: identifying a consumer location of the consumer; and determining the consumer product information for the consumer product selected by the consumer based on at least (i) at least one of health profile information of the consumer or health profile information of a consumer affiliated entity of the consumer and (ii) the consumer location relative to at least two of the consumer product locations; and (c) communicate to the consumer the consumer product information for the consumer product selected by the consumer.

Some embodiments include a method. The method can comprise executing one or more first computer instructions configured to determine consumer product information to communicate to a consumer. Executing the one or more first computer instructions can comprise: executing one or more second computer instructions configured to identify a selection of a consumer product by the consumer, the multiple consumer products including the consumer product; and responsive to the executing the one or more second computer instructions: executing one or more third computer instructions configured to identify a consumer location of the consumer; executing one or more fourth computer instructions configured to identify one or more geographic regions corresponding to the consumer location of the consumer; executing one or more fifth computer instructions configured to identify one or more regional health characteristics associated with the one or more geographic regions; and executing one or more sixth computer instructions configured to determine the consumer product information for the consumer product selected by the consumer based on at least (i) at least one of health profile information of the consumer or health profile information of a consumer affiliated entity of the consumer and (ii) the one or more regional health characteristics. The method further can comprise executing one or more seventh computer instructions configured to communicate to the consumer the consumer product information for the consumer product selected by the consumer. The one or more first computer instructions, the one or more second computer instructions, the one or more third computer instructions, the one or more fourth computer instructions, the one or more fifth computer instructions, the one or more sixth computer instructions, and the one or more seventh computer instructions can be configured to run at one or more processing modules and configured to be stored at one or more non-transitory memory storage modules.

Other embodiments include a system. The system comprises an input device, a display device, one or more processing modules, and one or more non-transitory memory storage modules storing computer instructions configured to run on the one or more processing modules and perform multiple acts. The multiple acts can include determining consumer product information to communicate to a consumer. Determining the consumer product information to communicate to the consumer can comprise: identifying a selection of a consumer product by the consumer, the multiple consumer products including the consumer product; and responsive to the identifying the selection of the consumer product by the consumer: identifying a consumer location of the consumer; identifying one or more geographic regions corresponding to the consumer location of the consumer; identifying one or more regional health characteristics associated with the one or more geographic regions; and determining the consumer product information for the consumer product selected by the consumer based on at least (i) at least one of health profile information of the consumer or health profile information of a consumer affiliated entity of the consumer and (ii) the one or more regional health characteristics. The multiple acts also can include communicating to the consumer the consumer product information for the consumer product selected by the consumer. Meanwhile, the input device and the display device can be configured to permit an operator of the one or more processing modules and the one or more non-transitory memory storage modules to manage the one or more processing modules and the one or more non-transitory memory storage modules.

Further embodiments include at least one non-transitory memory storage module having computer instructions stored thereon executable by one or more processing modules to: (a) determine consumer product information to communicate to a consumer by: identifying a selection of a consumer product by the consumer, the multiple consumer products including the consumer product; and responsive to the identifying the selection of the consumer product by the consumer: identifying a consumer location of the consumer; identifying one or more geographic regions corresponding to the consumer location of the consumer; identifying one or more regional health characteristics associated with the one or more geographic regions; and determining the consumer product information based on at least (i) at least one of health profile information of the consumer or health profile information of a consumer affiliated entity of the consumer and (ii) the one or more regional health characteristics; and (b) communicate to the consumer the consumer product information for the consumer product selected by the consumer.

Some embodiments include a method. The method can comprise: executing one or more first computer instructions configured to identify consumer product locations of multiple consumer products; executing one or more second computer instructions configured to determine a consumer health code based on health profile information of a consumer; and executing one or more third computer instructions configured to determine consumer product information to communicate to the consumer. Executing the one or more third computer instructions can comprise: executing one or more fourth computer instructions configured to identify a consumer location of the consumer; and executing one or more fifth computer instructions configured to determine the consumer product information based on at least (i) the consumer health code and (ii) the consumer location relative to at least two of the consumer product locations. The method further can comprise executing one or more sixth computer instructions configured to communicate to the consumer the consumer product information. The one or more first computer instructions, the one or more second computer instructions, the one or more third computer instructions, the one or more fourth computer instructions, the one or more fifth computer instructions, and the one or more sixth computer instructions are configured to run at one or more processing modules and configured to be stored at one or more non-transitory memory storage modules.

Other embodiments include a system. The system comprises an input device, a display device, one or more processing modules, and one or more non-transitory memory storage modules storing computer instructions configured to run on the one or more processing modules and perform multiple acts. The multiple acts can include identifying consumer product locations of multiple consumer products; determining a consumer health code based on health profile information of a consumer; and determining consumer product information to communicate to a consumer. Determining the consumer product information to communicate to the consumer can comprise: identifying a consumer location of the consumer; and determining the consumer product information based on at least (i) the consumer health code and (ii) the consumer location relative to at least two of the consumer product locations. The multiple acts also can comprise communicating to the consumer the consumer product information. Meanwhile, the input device and the display device can be configured to permit an operator of the one or more processing modules and the one or more non-transitory memory storage modules to manage the one or more processing modules and the one or more non-transitory memory storage modules.

Further embodiments include at least one non-transitory memory storage module having computer instructions stored thereon executable by one or more processing modules to: (a) identify consumer product locations of multiple consumer products; (b) determine a consumer health code based on health profile information of a consumer; (c) determine consumer product information to communicate to a consumer by: identifying a consumer location of the consumer; and determining the consumer product information based on at least (i) the consumer health code and (ii) the consumer location relative to at least two of the consumer product locations; and (d) communicate to the consumer the consumer product information.

Some embodiments include a method. The method can comprise: executing one or more first computer instructions configured to determine a consumer health code based on health profile information of a consumer; and executing one or more second computer instructions configured to determine consumer product information to communicate to the consumer. Executing the one or more second computer instructions can comprise: executing one or more third computer instructions configured to identify a consumer location of the consumer; executing one or more fourth computer instructions configured to identify one or more geographic regions corresponding to the consumer location of the consumer; executing one or more fifth computer instructions configured to identify one or more regional health characteristics associated with the one or more geographic regions; and executing one or more sixth computer instructions configured to determine the consumer product information for the consumer product selected by the consumer based on at least (i) the consumer health code and (ii) the one or more regional health characteristics. The method further can comprise executing one or more seventh computer instructions configured to communicate to the consumer the consumer product information for the consumer product selected by the consumer. The one or more first computer instructions, the one or more second computer instructions, the one or more third computer instructions, the one or more fourth computer instructions, the one or more fifth computer instructions, the one or more sixth computer instructions, and the one or more seventh computer instructions are configured to run at one or more processing modules and configured to be stored at one or more non-transitory memory storage modules.

Other embodiments include a system. The system comprises an input device, a display device, one or more processing modules, and one or more non-transitory memory storage modules storing computer instructions configured to run on the one or more processing modules and perform multiple acts. The multiple acts can include determining a consumer health code based on health profile information of a consumer; and determining consumer product information to communicate to the consumer. Determining the consumer product information to communicate to the consumer comprising: identifying a consumer location of the consumer; identifying one or more geographic regions corresponding to the consumer location of the consumer; identifying one or more regional health characteristics associated with the one or more geographic regions; and determining the consumer product information for the consumer product selected by the consumer based on at least (i) the consumer health code and (ii) the one or more regional health characteristics. The multiple acts also can include communicating to the consumer the consumer product information for the consumer product selected by the consumer. Meanwhile, the input device and the display device can be configured to permit an operator of the one or more processing modules and the one or more non-transitory memory storage modules to manage the one or more processing modules and the one or more non-transitory memory storage modules.

Further embodiments include at least one non-transitory memory storage module having computer instructions stored thereon executable by one or more processing modules to: (a) determine a consumer health code based on health profile information of a consumer; (b) determine consumer product information to communicate to the consumer by: identifying a consumer location of the consumer; identifying one or more geographic regions corresponding to the consumer location of the consumer; identifying one or more regional health characteristics associated with the one or more geographic regions; and determining the consumer product information for the consumer product selected by the consumer based on at least (i) the consumer health code and (ii) the one or more regional health characteristics; and (c) communicate to the consumer the consumer product information for the consumer product selected by the consumer.

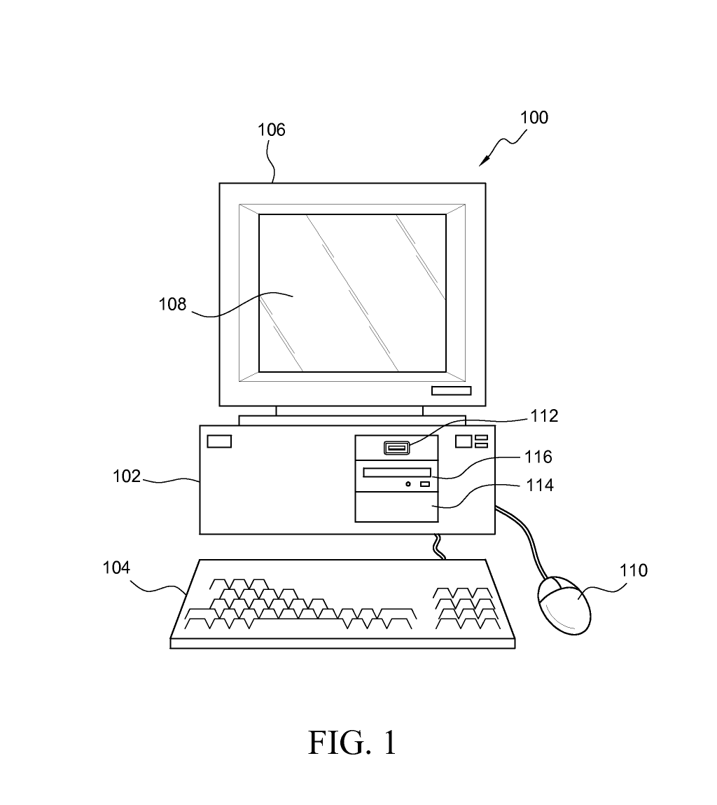

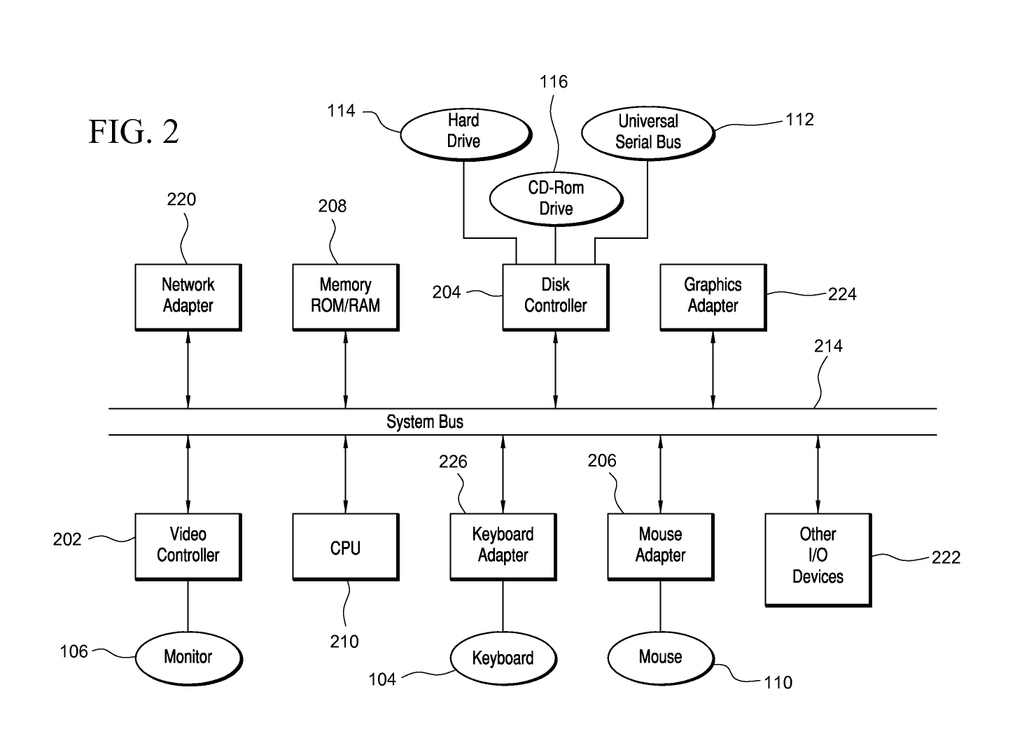

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a refreshing monitor 106, a keyboard 104, and/or a mouse 110, etc.) can also be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) volatile (e.g., transitory) memory, such as, for example, read only memory (ROM) and/or (ii) non-volatile (e.g., non-transitory) memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. The memory storage module(s) of the various embodiments disclosed herein can comprise memory storage unit 208, an external memory storage drive (not shown), such as, for example, a USB-equipped electronic memory storage drive coupled to universal serial bus (USB) port 112 (FIGS. 1-2), hard drive 114 (FIGS. 1-2), CD-ROM and/or DVD drive 116 (FIGS. 1-2), a floppy disk drive (not shown), an optical disc (not shown), a magneto-optical disc (now shown), magnetic tape (not shown), etc. Further, non-volatile or non-transitory memory storage module(s) refer to the portions of the memory storage module(s) that are non-volatile (e.g., non-transitory) memory.

In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise (i) Microsoft® Windows® operating system (OS) by Microsoft Corp. of Redmond, Wash., United States of America, (ii) Mac® OS by Apple Inc. of Cupertino, Calif., United States of America, (iii) UNIX® OS, and (iv) Linux® OS. Further exemplary operating systems can comprise (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smart phone. In certain additional embodiments, computer system 100 may comprise an embedded system.

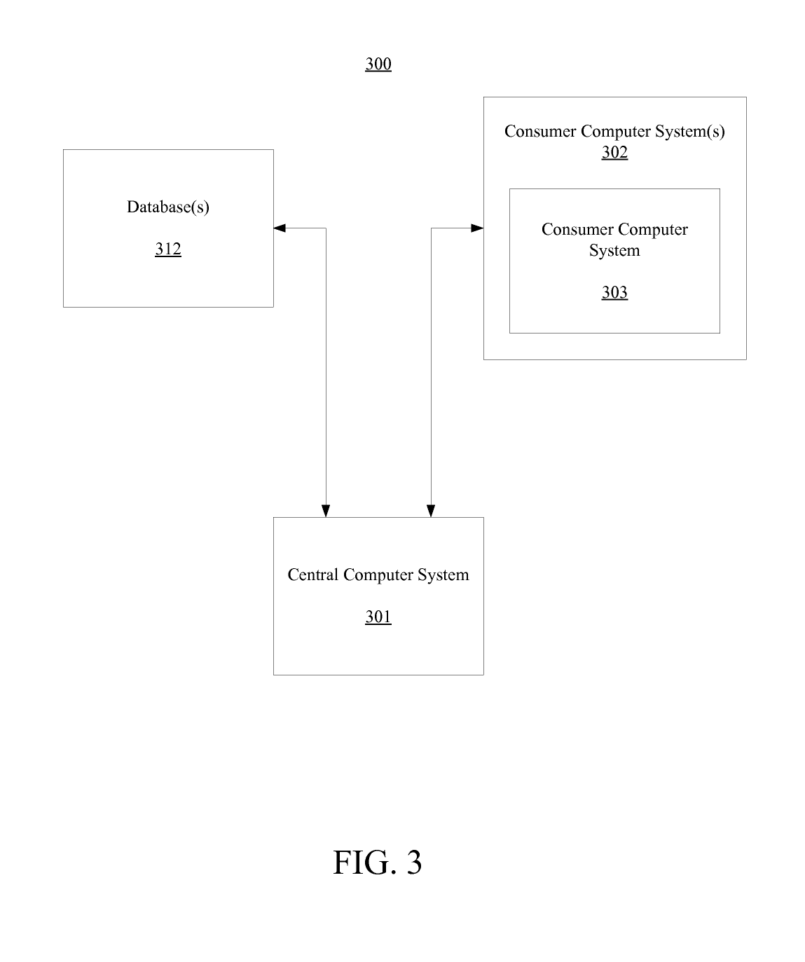

Skipping ahead now in the drawings, FIG. 3 illustrates a representative block diagram of a system 300, according to an embodiment. System 300 is merely exemplary and embodiments of the system are not limited to the embodiments presented herein. System 300 can be employed in many different embodiments or examples not specifically depicted or described herein. In some embodiments, certain elements or modules of system 300 can perform various methods and/or activities of those methods. In these or other embodiments, the methods and/or the activities of the methods can be performed by other suitable elements or modules of system 300.

As described in greater detail below, system 300 can be operable to communicate consumer product information (e.g., an alert regarding a consumer product, consumer product statistics of a consumer product, a suggestion of a consumer product, such as, for example a complimentary or alternative consumer product, etc.) for one or more consumer products to a consumer based on, for example, health profile information (e.g., one or more health codes) of the consumer and/or one or more consumer affiliated entities and a location (e.g., a physical location and/or a relative location) of the consumer. Accordingly, system 300 can inform (e.g., educate) consumers about consumer products, such as, for example, when consumers are making purchasing decisions. In particular, system 300 can help consumers to select healthier options tailored to the specific health needs of the consumer and/or of others (e.g., relatives, co-inhabitants, pets, etc.) associated with the consumers.

As further described in greater detail below, in these or other embodiments, system 300 can proactively (e.g., prospectively) and/or reactively (e.g., responsively) determine and/or communicate the consumer product information to the consumer, as desired. Proactive acts can refer to acts (e.g., identification, determination, communication, etc.) performed without consideration of one or more predetermined acts performed by the consumer; and reactive acts can refer to acts (e.g., identification, determination, communication, etc.) performed with consideration of (i.e., in response to) one or more predetermined acts performed by the consumer. For example, in some embodiments, the predetermined act(s) can comprise an act of identifying a selection of a consumer product by the consumer.

Meanwhile, as also described in greater detail below, system 300 can be implemented in brick-and-mortar commerce and/or electronic commerce applications, as desirable. Further, in many of these or other embodiments, system 300 can communicate the consumer product information to the consumer substantially in real-time (e.g., near real-time), such as, for example: (i) as the health profile information (e.g., the health code(s)) of the consumer and/or the consumer affiliated entities and/or as the location of the consumer are updated, and/or (ii) upon occurrence of the predetermined act(s) performed by the consumer, as applicable. Near real-time can mean real-time less a time delay for processing (e.g., determining) and/or transmitting the relevant consumer product information to the relevant consumer. The particular time delay can vary depending on the type and/or amount of the consumer product information, the processing speed(s) of the processing module(s) of system 300, the transmission capability of the communication hardware (as introduced below), the transmission distance, etc. However, in many embodiments, the time delay can be less than approximately one, five, ten, or twenty minutes.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Specifically, system 300 comprises a central computer system 301. In many embodiments, central computer system 301 can be similar or identical to computer system 100 (FIG. 1). Accordingly, central computer system 301 can comprise one or more processing modules and one or more memory storage modules (e.g., one or more non-transitory memory storage modules). In these or other embodiments, the processing module(s) and/or the memory storage module(s) can be similar or identical to the processing module(s) and/or memory storage module(s) (e.g., non-transitory memory storage modules) described above with respect to computer system 100 (FIG. 1). In some embodiments, central computer system 301 can comprise a single computer or server, but in many embodiments, central computer system 301 comprises a cluster or collection of computers or servers and/or a cloud of computers or servers. Meanwhile, central computer system 301 can comprise one or more input devices (e.g., one or more keyboards, one or more keypads, one or more pointing devices such as a computer mouse or computer mice, one or more touchscreen displays, etc.), and/or can comprise one or more display devices (e.g., one or more monitors, one or more touch screen displays, etc.). In these or other embodiments, one or more of the input device(s) can be similar or identical to keyboard 104 (FIG. 1) and/or a mouse 110 (FIG. 1). Further, one or more of the display device(s) can be similar or identical to refreshing monitor 106 (FIG. 1) and/or screen 108 (FIG. 1). The input device(s) and the display device(s) can be coupled to the processing module(s) and/or the memory storage module(s) of central computer system 301 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of central computer system 301. In a similar maner, the processing module(s) and the memory storage module(s) can be local and/or remote to each other.

In many embodiments, central computer system 301 is configured to communicate with one or more consumer computer systems 302 (e.g., a consumer computer system 303) of one or more consumers. For example, the consumer(s) can interface (e.g., interact) with central computer system 301, and vice versa, via consumer computer system(s) 302 (e.g., consumer computer system 303). Accordingly, in many embodiments, central computer system 301 can refer to a back end of system 300 operated by an operator and/or administrator of system 300, and consumer computer system(s) 302 can refer to a front end of system 300 used by one or more users of system 300 (i.e., the consumer(s)). In these or other embodiments, the operator and/or administrator of system 300 can manage central computer system 301, the processing module(s) of computer system 301, and/or the memory storage module(s) of computer system 301 using the input device(s) and/or display device(s) of central computer system 301. In some embodiments, system 300 can comprise consumer computer system(s) 302 (e.g., consumer computer system 303).

Like central computer system 301, consumer computer system(s) 302 each can be similar or identical to computer system 100 (FIG. 1), and in many embodiments, each of consumer computer system(s) 302 can be similar or identical to each other. In many embodiments, consumer computer system(s) 302 can comprise one or more desktop computer devices, one or more wearable user computer devices, and/or one or more mobile electronic devices, etc. At least part of central computer system 301 can be located remotely from consumer computer system(s) 302.

In many embodiments, a mobile electronic device can refer to a portable electronic device (e.g., an electronic device easily conveyable by hand by a person of average size) with the capability to present audio and/or visual data (e.g., images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For examples, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ or a similar product by Google Inc. of Menlo Park, Calif., United States of America; (ii) the Eye Tap™, the Laser Eye Tap™, or a similar product by ePI Lab of Toronto, Ontario, Canada, and/or (iii) the Raptyr™, the STAR 1200™, the Vuzix Smart Glasses M100™, or a similar product by Vuzix Corporation of Rochester, N.Y., United States of America. In other specific examples, a head mountable wearable user computer device can comprise the Virtual Retinal Display™, or similar product by the University of Washington of Seattle, Wash., United States of America. Meanwhile, in further specific examples, a limb mountable wearable user computer device can comprise the iWatch™, or similar product by Apple Inc. of Cupertino, Calif., United States of America, and/or the Zip™, One™, Flex™, Charge™, Surge™, or similar product by Fitbit Inc. of San Francisco, Calif., United States of America.

In further embodiments, central computer system 301 can be configured to communicate with software (e.g., one or more web browsers, one or more mobile software applications, etc.) of the consumer computer system(s) 302 (e.g., consumer computer system 303). For example, the software can run on one or more processing modules and can be stored on one or more memory storage modules (e.g., one or more non-transitory memory storage modules) of the consumer computer system(s) 302 (e.g., consumer computer system 303). In these or other embodiments, the processing module(s) of the consumer computer system(s) 302 (e.g., consumer computer system 303) can be similar or identical to the processing module(s) described above with respect to computer system 100 (FIG. 1). Further, the memory storage module(s) (e.g., non-transitory memory storage modules) of the consumer computer system(s) 302 (e.g., consumer computer system 303) can be similar or identical to the memory storage module(s) (e.g., non-transitory memory storage module(s)) described above with respect to computer system 100 (FIG. 1). Exemplary web browsers can include (i) Firefox® by the Mozilla Organization of Mountain View, Calif., United States of America, (ii) Internet Explorer® by the Microsoft Corp. of Redmond, Wash., United States of America, (iii) Chrome™ by Google Inc. of Menlo Park, Calif., United States of America, (iv) Opera® by Opera Software of Oslo, Norway, and (v) Safari® by Apple Inc. of Cupertino, Calif., United States of America.

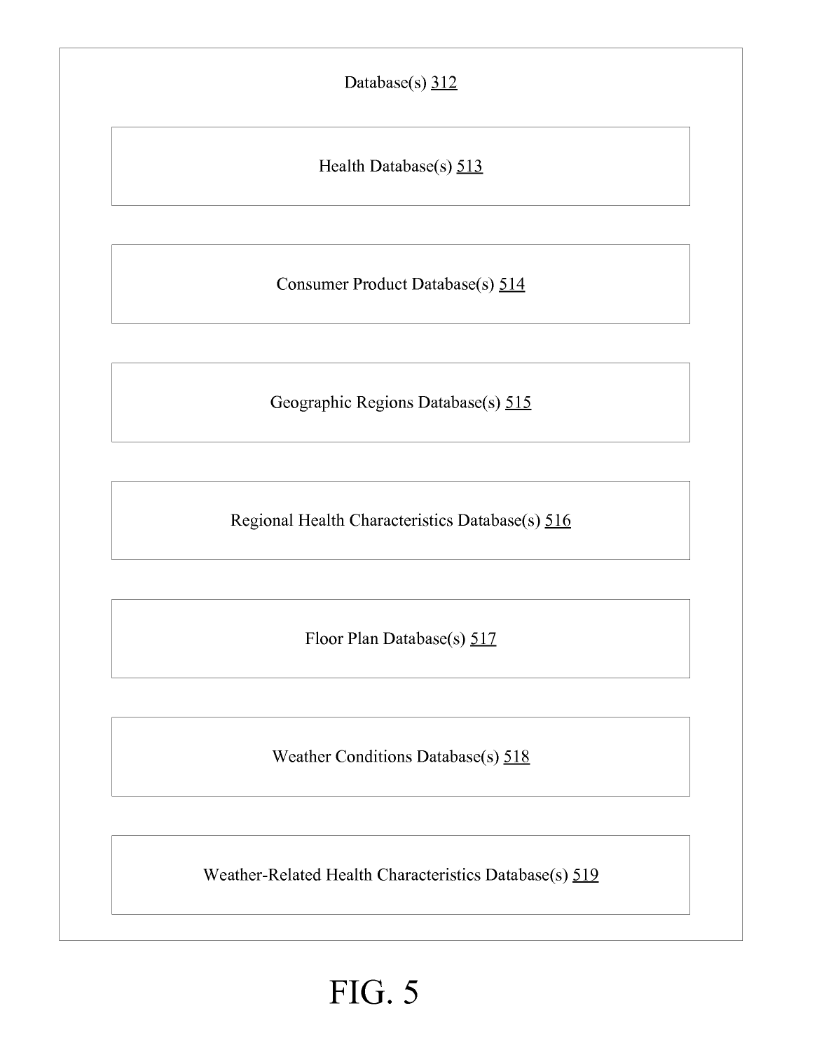

Meanwhile, in many embodiments, central computer system 301 also can be configured to communicate with one or more databases 312 (e.g., one or more health databases 513 (FIG. 5), one or more computer product databases 514 (FIG. 5), one or more geographic regions databases 515 (FIG. 5), one or more regional health characteristics databases 516 (FIG. 5), one or more floor plan databases 517 (FIG. 5), weather conditions database(s) 518 (FIG. 5), and/or weather-related health characteristics database(s) 519 (FIG. 5)). Database(s) 312 can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of database(s) 312, that particular database can be stored on a single memory storage module of the memory storage module(s) and/or the non-transitory memory storage module(s) storing database(s) 312 or it can be spread across multiple of the memory storage module(s) and/or non-transitory memory storage module(s) storing database(s) 312, depending on the size of the particular database and/or the storage capacity of the memory storage module(s) and/or non-transitory memory storage module(s).

In these or other embodiments, the memory storage module(s) of central computer system 300 can comprise some or all of the memory storage module(s) storing database(s) 312. In further embodiments, some of the memory storage module(s) storing database(s) 312 can be part of consumer computer systems 302 and/or one or more third-party computer systems (i.e., other than central computer system 301 and consumer computer systems 302), and in still further embodiments, all of the memory storage module(s) storing database(s) 312 can be part of consumer computer systems 302 and/or the third-party computer system(s). Like central computer system 301 and consumer computer system(s) 302, when applicable, each of the third-party computer system(s) can be similar or identical to computer system 100 (FIG. 1). Notably, the third-party computer systems are omitted from the drawings to better illustrate that database(s) 312 can be stored at memory storage module(s) of central computer system 301, consumer computer system(s) 302, and/or the third-party computer systems, depending on the manner in which system 300 is implemented.

Database(s) 312 each can comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database and IBM DB2 Database.

Meanwhile, communication between central computer system 301, consumer computer system(s) 302 (e.g., consumer computer system 303), and/or database(s) 312 can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), Powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3, IEEE 802.11, etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/Time Division Multiple Access (TDMA)), Integrated Digital Enhanced Network (iDEN), etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.

For convenience, the functionality of system 300 is described herein as it relates particularly to consumer computer system 303 and a single consumer, but in many embodiments, the functionality of system 300 can be extended to each of consumer computer system(s) 302 and/or to multiple consumers. In these extended examples, in some embodiments, single consumers can interface (e.g., interact) with central computer system 301 with multiple consumer computer systems of consumer computer system(s) 302 (e.g., at different times). For example, a consumer could interface with central computer system 301 via a first consumer computer system (e.g., a desktop computer), such as, for example, when interfacing with central computer system 301 from home, and via a second consumer computer system (e.g., a mobile electronic device), such as, for example, when interfacing with central computer system 301 away from home.

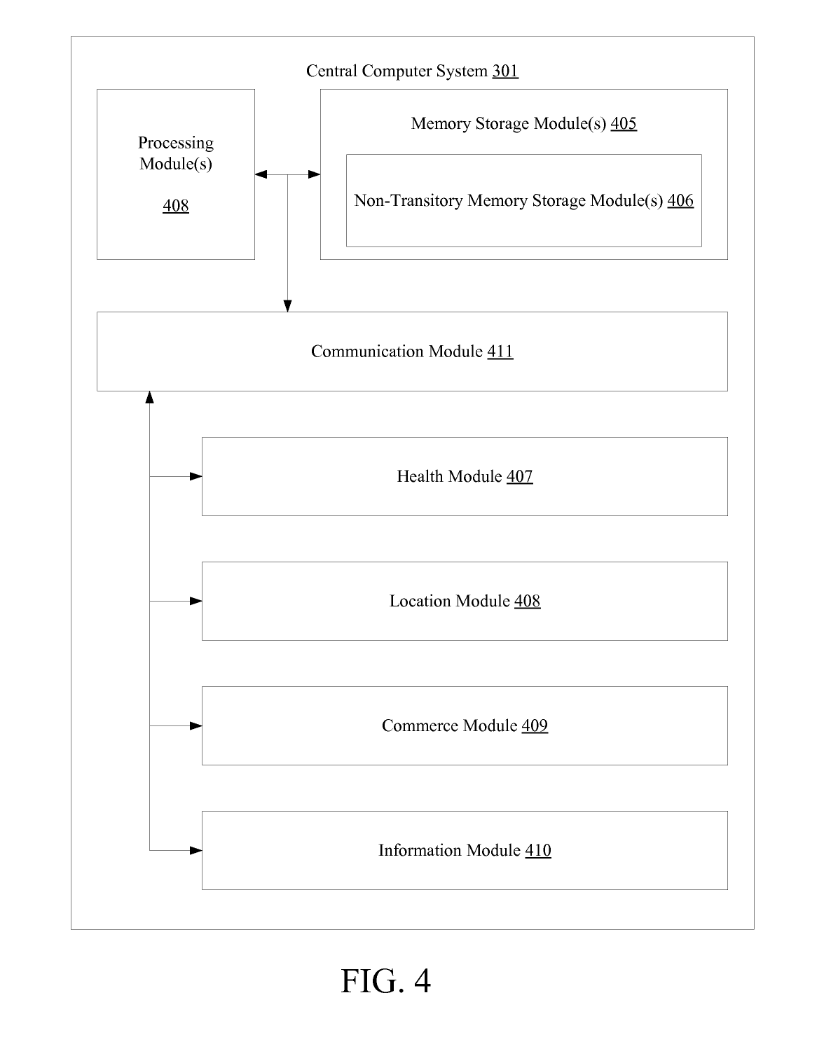

Turning ahead now in the drawings, FIG. 4 illustrates a representative block diagram of central computer system 301, according to the embodiment of FIG. 3; and FIG. 5 illustrates a representative block diagram of database(s) 312, according to the embodiment of FIG. 3.

Referring first to FIG. 4, in many embodiments, central computer system 301 can comprise one or more processing modules 404, one or more memory storage modules 405, a health module 407, a location module 408, a commerce module 409, an information module 410, and a communication module 411. Further, memory storage module(s) 405 can comprise non-transitory memory storage module(s) 406. In some embodiments, part or all of at least one or more of health module 407, location module 408, commerce module 409, information module 410, and communication module 411 can be part of at least one or more others of health module 407, location module 408, commerce module 409, information module 410, and communication module 411, and vice versa.

Meanwhile, referring briefly to FIG. 5, database(s) 312 can comprise health database(s) 513, computer product database(s) 514, geographic regions database(s) 515, regional health characteristics database(s) 516, floor plan database(s) 517, weather conditions database(s) 518, and/or weather-related health characteristics database(s) 519. In some embodiments, part or all of at least one or more of health database(s) 513, computer product database(s) 514, geographic regions database(s) 515, regional health characteristics database(s) 516, floor plan database(s) 517, weather conditions database(s) 518, and/or weather-related health characteristics database(s) 519 can be part of at least one or more others of health database(s) 513, computer product database(s) 514, geographic regions database(s) 515, regional health characteristics database(s) 516, floor plan database(s) 517, weather conditions database(s) 518, and/or weather-related health characteristics database(s) 519 and vice versa. In some embodiments, one or more of health database(s) 513, computer product database(s) 514, geographic regions database(s) 515, regional health characteristics database(s) 516, floor plan database(s) 517, weather conditions database(s) 518, and/or weather-related health characteristics database(s) 519 can be omitted.

Returning now to FIG. 4, in many embodiments, processing module(s) 404 can be similar or identical to the processing module(s) described above with respect to computer system 100 (FIG. 1) and/or central computer system 301 (FIG. 3); memory storage module(s) 405 can be similar or identical to the memory storage module(s) described above with respect to computer system 100 (FIG. 1) and/or central computer system 301 (FIG. 3); and/or non-transitory memory storage module(s) 406 can be similar or identical to the non-transitory memory storage module(s) described above with respect to computer system 100 (FIG. 1) and/or central computer system 301 (FIG. 3). Further, health module 407, location module 408, commerce module 409, information module 410, and/or communication module 411 can be implemented with hardware and/or software, as desirable. Although health module 407, location module 408, commerce module 409, information module 410, and/or communication module 411 are shown at FIG. 4 as being separate from processing module(s) 404, memory storage module(s) 405, and/or non-transitory memory storage module(s) 406, in many embodiments, part or all of health module 407, location module 408, commerce module 409, information module 410, and/or communication module 411 can be stored at memory storage module(s) 405 and/or non-transitory memory storage module(s) 406 and can be called and run at operating module(s) 404, such as, for example, when the part or all of health module 407, location module 408, commerce module 409, information module 410, and/or communication module 411 are implemented as software.

### Communication Module 411

Communications module 411 is operable to provide and manage communication between the various elements of central computer system 301 (e.g., processing module(s) 404, memory storage module(s) 405, non-transitory memory storage module(s) 406, health module 407, location module 408, commerce module 409, information module 410, etc.) and manage incoming and outgoing communications between central computer system 301 (FIG. 3) and consumer computer system(s) 302 of FIG. 3 (e.g., consumer computer system 303 (FIG. 3)) and/or database(s) 312 (FIG. 3). Like the communications between central computer system 301 (FIG. 3), consumer computer system(s) 302 (FIG. 3), and/or database(s) 312 (FIG. 3), communication module 411 can be implemented using any suitable manner of wired and/or wireless communication, and/or using any one or any combination of wired and/or wireless communication network topologies and/or protocols, as described above with respect to the central computer system 301 (FIG. 3), consumer computer system(s) 302 (FIG. 3), and/or database(s) 312 (FIG. 3). In many embodiments, communication module 411 can be part of hardware and/or software implemented for communications between central computer system 301 (FIG. 3), consumer computer system(s) 302 (FIG. 3), and/or database(s) 312 (FIG. 3). For example, as applicable, communication module 411 can permit processing module(s) 404 to call (i) software (e.g., at least part of health module 407, location module 408, commerce module 409, information module 410, etc.) stored at memory storage module(s) 405 and/or non-transitory memory storage module(s) 406, and/or (ii) data stored at memory storage module(s) 405, at non-transitory memory storage module(s) 406, and/or in database(s) 312 (FIG. 3).

### Health Module 407

Health module 407 is operable create, query, organize, update, and/or manage a health profile of the consumer, and in some embodiments, one or more health profiles of one or more consumer affiliated entities of the consumer. As explained in greater detail below, when applicable, the consumer affiliated entity health profile(s) can be associated with (e.g., linked with) the consumer health profile. Further, in some of these embodiments, the consumer health profile can comprise the consumer affiliated entity health profile(s), though in other embodiments, the consumer affiliated entity health profile(s) are separate from the consumer health profile. Meanwhile, as also explained in greater detail below, in some examples, the consumer health profile may not be associated with any consumer affiliated entity health profile(s).

The consumer health profile can include health profile information of the consumer, and the consumer affiliated entity health profile(s) can include health profile information of the one or more consumer affiliated entities. Further, the one or more consumer affiliated entities can comprise one or more persons and/or animal (e.g., pets) associated with the consumer. In these or other embodiments, the person(s) associated with the consumer can comprise one or more relatives of the consumer and/or one or more co-inhabitants with the consumer. The health profile information of the consumer, and as applicable, the health profile information of the one or more consumer affiliated entities can be stored (e.g., indexed) at health database(s) 513 (FIG. 5).

The health profile information of the consumer can comprise (i) identification information, (ii) one or more physical characteristics, (iii) one or more physical conditions, (iv) one or more medical prescriptions of the consumer, (v) financial information of the consumer, and/or (vi) one or more health goals of the consumer, and the health profile information of the one or more consumer affiliated entities can comprise (i) identification information, (ii) one or more physical characteristics, (iii) one or more physical conditions, (iv) one or more medical prescriptions, (v) financial information of the one or more consumer affiliated entities, and/or (vi) one or more health goals of the one or more consumer affiliated entities.

The identification information can comprise any suitable information associable with the consumer and/or one or more consumer affiliated entities, as applicable, to identify that consumer and/or those one or more consumer affiliated entities and/or to distinguish that consumer and/or those one or more consumer affiliated entities from other persons and/or animals. Exemplary identification information can include one or more names, one or more street addresses, one or more phone numbers, one or more email addresses, a serial number (e.g., a social security number, a drivers license number, an account number, such as, for example, a credit card number, a debit card number, a checking account number, a savings account number, etc., a system specific number assigned by the operator or administrator of system 300 (FIG. 3), etc.), etc. of the consumer and/or the one or more consumer affiliated entities, as applicable. Exemplary identification information also can include one or more names, one or more registration numbers, a genus, a class, a species, etc. when the consumer affiliated entities include one or more animals (e.g., pets) associated with the consumer.

Further, the physical characteristic(s) can comprise one or more physical parameters corresponding to the consumer and/or to the one or more consumer affiliated entities, as applicable. As an example, the physical characteristic(s) of a consumer affiliated entity can include the physical characteristic(s) of a single member of the consumer affiliated entity, the aggregate, average, and/or individual physical characteristic(s) of all of the members of the consumer affiliated entity, and/or the aggregate, average, and/or individual physical characteristic(s) of only a portion of the members of the consumer affiliated entity. Exemplary physical characteristic(s) can include an age, a height, a weight, a body mass index, a visual acuity, a nationality, a gender, a fitness level, etc. of the consumer and/or the one or more consumer affiliated entities, as applicable.

The physical condition(s) can comprise one or more maladies (e.g., diseases, disorders, etc.) of the consumer and/or the one or more consumer affiliated entities, as applicable. As an example, the physical condition(s) of a consumer affiliated entity can include the physical condition(s) of a single member of the consumer affiliated entity, the aggregate, average, and/or individual physical condition(s) of all of the members of the consumer affiliated entity, and/or the aggregate, average, and/or individual physical condition(s) of only a portion of the members of the consumer affiliated entity. Exemplary physical condition(s) can include obesity, skeletal diseases and disorders, muscular diseases and disorders, cardiovascular diseases and disorders, digestive diseases and disorders, endocrine diseases and disorders, neurological diseases and disorders, respiratory diseases and disorders, immune/lymphatic diseases and disorders, urinary diseases and disorders, reproductive diseases and disorders, integumentary diseases and disorders, and/or infection diseases. More specific exemplary physical condition(s) can include cancer, heart disease, diabetes, hypertension, attention deficit disorder, attention deficit/hyperactive disorder, hypercholesterolemia, hyperthyroidism, hypothyroidism, asthma, influenza infection, chlamydia infection, epilepsy, anxiety disorder, herpes simplex infection, gonorrhea infection, hepatitis infection, human immunodeficiency virus (HIV) infection, human papillomavirus infection, meningitis infection, streptococcus infection, etc.

The medical prescription(s) can comprise one or more medications and/or dietary supplements prescribed to treat one or more maladies of the consumer and/or the one or more consumer affiliated entities, as applicable. As an example, the medical prescription(s) of a consumer affiliated entity can include the medical prescription(s) of a single member of the consumer affiliated entity, the aggregate, average, and/or individual medical prescription(s) of all of the members of the consumer affiliated entity, and/or the aggregate, average, and/or individual medical prescription(s) of only a portion of the members of the consumer affiliated entity.

Further still, the financial information can comprise any information associable with the finances of the consumer and/or the one or more consumer affiliated entities, as applicable. Exemplary financial information can include an income and/or an insurance coverage (e.g., an insurance plan, a health savings account, etc.) of the consumer and/or the one or more consumer affiliated entities, as applicable. As an example, the income of a consumer affiliated entity can include the income of a single member of the consumer affiliated entity, the aggregate and/or average income of all of the members of the consumer affiliated entity, and/or the aggregate and/or average income of only a portion of the members of the consumer affiliated entity. Similarly, as another example, the insurance coverage of a consumer affiliated entity can include the insurance coverage of a single member of the consumer affiliated entity, the aggregate, average, and/or individual insurance coverage for all of the members of the consumer affiliated entity, or the aggregate, average, and/or individual insurance coverage for only a portion of the members of the consumer affiliated entity.

Meanwhile, the health goals can comprise one or more goals for changing the one or more physical characteristics and/or the one or more physical conditions of the consumer and/or the one or more consumer affiliated entities, as applicable. As an example, the heath goals of a consumer affiliated entity can include the health goals of a single member of the consumer affiliated entity, the aggregate, average, and/or individual health goals of all of the members of the consumer affiliated entity, or the aggregate, average, and/or individual health goals of only a portion of the members of the consumer affiliated entity. Exemplary health goals can include achieving a predetermined change in weight, achieving a predetermined change in glucose level, achieving a predetermined change in blood pressure, achieving a predetermined change in cholesterol, etc. The change can be according to a particular number or by a percentage difference.

In many embodiments, system 300 (FIG. 3) and/or health module 407 can create the consumer health profile and/or consumer affiliated entity health profile(s) at the request of the consumer. In particular, if the consumer desires to avail herself of the consumer product information provided by system 300 (FIG. 3), the consumer can request system 300 and/or health module 407 (e.g., contract with the operator and/or administrator of system 300) to create, update, and manage a consumer health profile on her behalf. The request can be solicited (e.g., by health module 407 via communication module 411) or unsolicited, and can be received by system 300 (FIG. 3) and/or health module 407 via communication module 411. As explained further below, in some embodiments, the consumer also can request to create one or more consumer affiliated entity health profiles for association with the consumer health profile and/or request to link the consumer health profile with one or more existing consumer affiliated entity health profiles for association with the consumer health profile.

In some embodiments, after receiving the request to create a consumer health profile, central computer system 301 (FIG. 3) and/or health module 407 can receive the health profile information of the consumer from which to build the consumer health profile. When applicable, central computer system 301 (FIG. 3) and/or health module 407 also can receive the health profile information of the one or more consumer affiliated entities from which to build the consumer affiliated entity health profile(s).

In various embodiments, part or all of the health profile information of the consumer, and of the one or more consumer affiliated entities when applicable, can be received via communication module 411 from a medical diagnostic computer system used by the consumer. For example, the medical diagnostic computer system can comprise a health and wellness screening system configured to determine (e.g., sense) one or more physical characteristics and/or conditions of the consumer. Further, in these or other examples, the medical diagnostic computer system can receive identification information, medical prescription information, other physical characteristic(s), other physical condition(s), financial information, and/or health goals of the health profile information by one or more input devices (e.g., a keyboard, a mouse, a touch screen electronic display, a microphone, etc.) of the medical diagnostic computer system. In many of these examples, the medical diagnostic computer system can be located at a brick-and-mortar retail store. Accordingly, in some embodiments, system 300 (FIG. 3) can comprise one or more medical diagnostic computer systems, each of which can be similar or identical to each other. In these or other embodiments, at least part of the medical diagnostic computer system(s) can be similar or identical to computer system 100 (FIG. 1), and the medical diagnostic computer system(s) each can include one or more medical diagnostic sensors.

In some embodiments, communication module 411 can solicit the consumer at the medical diagnostic computer system to create the consumer health profile. If the consumer agrees, the medical diagnostic computer system can provide the part or all of the health profile information to central computer system 301 (FIG. 3) and/or health module 407. Accordingly, in these embodiments, communication module 411 can communicate with the medical diagnostic computer system using any suitable manner of wired and/or wireless communication, and/or using any one or any combination of wired and/or wireless communication network topologies and/or protocols, as similarly described above with respect to the communications between central computer system 301 (FIG. 3), consumer computer system(s) 302 (FIG. 3), and database(s) 312 (FIG. 3).

Meanwhile, in further embodiments, part or all of the health profile information of the consumer, and of the one or more consumer affiliated entities when applicable, can be received via communication module 411 from consumer computer system 303 (FIG. 3)) and/or from one or more third-party computer systems having part or all of the health profile information of the consumer (e.g., one or more computer systems of one or more medical practitioners treating the consumer). In many embodiments, these third-party computer system(s) also can be similar or identical to computer system 100 (FIG. 1).

In many embodiments, after the consumer health profile is created, central computer system 301 (FIG. 3) and/or health module 407 can make available the consumer health profile, and the consumer affiliated entity health profile(s) when applicable, to the consumer for viewing and/or updating via communication module 411. For example, as when originally creating the consumer health profile, the consumer can view and/or update the consumer health profile at consumer computer system 303 (FIG. 3) and/or at a medical diagnostic computer system. As a result, the health profile information of the consumer and/or consumer affiliated entities can be accurately maintained, and can aggregate the health profile information of the consumer and/or consumer affiliated entities for reference by the consumer. In some embodiments, central computer system 301 (FIG. 3) and/or health module 407 can make available the consumer health profile, and the consumer affiliated entity health profile(s) in applicable embodiments, to one or more third-parties (e.g., one or more medical practitioners treating the consumer, one or more health insurance providers, one or more mobile application providers, etc.) for viewing, updating, and/or compiling at their third-party computer system(s). In many embodiments, for purposes of security, central computer system 301 (FIG. 3) and/or health module 407 can require the consumer and/or the one or more third parties to provide credentials in order to access the consumer health profile, and the consumer affiliated entity health profile(s) in applicable embodiments. Exemplary credentials can include a user name, a password, a date of birth, one or more answers to one or more security questions, etc.

In many embodiments, whether creating or updating the health profile information, central computer system 301 (FIG. 3) and/or health module 407 can prompt the consumer to provide any applicable health profile information of the consumer and/or consumer affiliated entities through a tutorial (e.g., wizard) to facilitate (e.g., help) the consumer providing the health profile information of the consumer and/or the consumer affiliated entities. For example, the tutorial (e.g., wizard) can provide instructions to the consumer on providing the health profile information of the consumer and/or the consumer affiliated entities, such as, for example, according to one or more particular (e.g., standardized) formats.

Meanwhile, addressing the consumer affiliated entity health profile(s) in greater detail, the consumer can optionally create and/or link consumer affiliated entity health profile(s) with her consumer health profile, as introduced above, for association with the consumer health profile. In some embodiments, the consumer can request that central computer system 301 (FIG. 3) and/or health module 407 create the consumer affiliated entity health profile(s). In these or other embodiments, the consumer health profile can comprise the consumer affiliated entity health profile(s), which can be represented as sub-profiles of the consumer health profile. Further in these or other embodiments, the consumer affiliated entity health profile(s) can comprise one or more consumer health profile(s) of one or more other consumers (i.e., created on behalf of the other consumer(s)), in which case the consumer affiliated entity health profile(s) can be linked with the consumer health profile. In some embodiments, the consumer can view and/or update the consumer affiliated entity health profile(s), such as, for example, when her consumer health profile comprises the consumer affiliated entity health profile(s). In other embodiments, the consumer may not view and/or update the consumer affiliated entity health profile(s), whether or not the consumer health profile comprises the consumer affiliated entity health profile(s), such as, for example, for data privacy reasons. In some embodiments, when the one or more consumer affiliated entities comprise one or more persons, the person(s) associated with the consumer affiliated entity health profile(s) can elect whether or not the consumer can view and/or update her consumer affiliated entity health profile. Still, to the extent the consumer does not have or does not want to include or link any consumer affiliated entity health profile(s) with the consumer health profile, the consumer health profile can stand alone. In general, the relevance of these consumer affiliated entity health profile(s) will be better understood in context with information module 410 (discussed below) and in further context with health module 407.

In many embodiments, central computer system 301 (FIG. 3) and/or health module 407 can determine (e.g., calculate) a consumer health code based on the health profile information of the consumer. The consumer health code can comprise a summary metric by which to rate a health and wellness of the consumer, generally and/or with respect to specific physical condition(s) and/or medical prescription(s) of the consumer. The particular manner of implementing the consumer health code can depend on the level of specificity desired weighed against the increased time necessary to interpret the consumer health code. Further, the consumer health code can be configured to indicate a summary metric of the consumer's health and wellness in a confidential or pseudo-confidential (e.g., less intrusive and/or less detailed) manner. In some embodiments, central computer system 301 (FIG. 3) and/or health module 407 can determine (e.g., calculate) a dichotomy of consumer health sub-codes based on specific parts of the health profile information (e.g., specific physical condition(s) and/or medical prescription(s)) of the consumer, and the consumer health code can be determined from the consumer health sub-codes. In some of these embodiments, the consumer health code can comprise a character (e.g., an alphanumeric character) array or matrix of the consumer health sub-codes, while in other of these embodiments, the consumer health code can comprise a new code determined based on the consumer health sub-codes (e.g., an average or a summation of the consumer health sub-codes, etc.). In other embodiments, the consumer health code can comprise a single character (e.g., alphanumeric character, etc.).

For example, in some embodiments, the consumer health code can comprise a character (e.g., an alphanumeric character) array or matrix, wherein the various characters and their positions signify a relative health and wellness of the consumer generally and/or with respect to specific physical condition(s) and/or medical prescription(s) of the consumer. In these embodiments, the positions can correspond to the consumer health sub-codes. For example, a character in a first position of the character array or matrix can correspond to a general health and wellness of the consumer. Further, one or more second, third, fourth, etc. positions of the character array or matrix can correspond to one or more specific physical condition(s) and/or medical prescription(s) of the consumer. The size of the array or matrix can depend on the level of specificity desired and/or the quantity of relevant physical condition(s) and/or medical prescription(s) of the consumer. In these or other embodiments, making the consumer health code more generic can increase the level of confidentiality of the health profile information symbolized by the consumer health code.

In these or other embodiments, the consumer health code, and the consumer health sub-codes as applicable, can comprise a score (e.g., an alphanumeric score), such as for example, a particular value within a range of values wherein a value at one end of the range is most ideal and a value at the opposite of the range is least ideal. The number of values in the range can be increased for greater specificity or decreased for less specificity.

In some embodiments, health module 407 can determine (e.g., calculate) one or more consumer affiliated entity health codes based on health profile information of the one or more consumer affiliated entities. The consumer affiliated entity health code(s) can be similar or identical to the consumer health code as applied to each corresponding consumer affiliated entity. In some embodiments, the consumer health code can be further determined based on the consumer affiliated entity health code(s), and in other embodiments, the consumer affiliated entity health code(s) can be separately maintained. In general, the relevance of these consumer affiliated entity health code(s) will be better understood in context with information module 410 (discussed below).

In some embodiments, health module 407 can send solicitations (e.g., advertisements, incentives, offers, etc.) to the consumer as part of the process of creating and/or updating the consumer health profile and/or consumer affiliated entity health profile(s).

### Commerce Module 409

Commerce module 409 is operable to define, create, query, organize, update, and/or manage inventory information stored (e.g., indexed) at consumer product database(s) 514 (FIG. 5) corresponding to consumer products inventories of one or more electronic commerce websites and/or mobile application(s) and/or of one or more brick-and-mortar stores. The consumer products inventories each comprise consumer products available for purchase by the consumer at the electronic commerce website(s) and/or mobile application(s) and/or at the brick-and-mortar store(s). Commerce module 409 can communicate with consumer product database(s) 514 (FIG. 5) via communication module 411.

In many embodiments, the consumer products of the consumer product inventories can comprise any suitable commodities. In specific examples, consumer products can comprise nutritional consumer products (e.g., food, beverages, etc.), pharmacological consumer products (e.g., medications, dietary supplements, etc.), etc. In some embodiments, consumer products also can include consumer services (e.g., a vision test, a massage, etc.). As explained in greater detail with respect to information module 410, in many examples, system 300 can be advantageously implemented where one or more of the consumer products react health adversely with one or more physical condition(s) and/or medical prescription(s) of the consumer, and/or where two or more of the consumer products react health adversely with each other respective to the consumer.

Commerce module 409 can make available (e.g., display) the inventory information to the consumer at consumer computer system 303 (FIG. 3) via communication module 411, such as, for example, at an electronic display of consumer computer system 303. For example, commerce module 409 can permit the consumer to browse, search, and/or organize the inventory information at consumer computer system 303. In general, commerce module 409 can make available (e.g., display) the inventory information to the consumer at consumer computer system 303 (FIG. 3) in any suitable format. However, in many embodiments, commerce module 409 can make available the inventory information in the format of a conventional graphical user interface of an electronic commerce website and/or mobile application. In some embodiments, the inventory information for each of the electronic commerce website(s) and/or brick-and-mortar store(s) can be made available (e.g., displayed) separately or together, as desirable.

In these or other embodiments, commerce module 409 can permit the consumer to select one or more consumer products of the consumer product inventories and can identify these selections. Selections of consumer products can comprise expressions of interest in the consumer products by the consumer.

In many embodiments, the consumer can select the consumer products at consumer computer system 303 (FIG. 3), such as, for example, by scanning the consumer products (e.g., scanning labels, bar codes, quick response (QR) codes, etc. of the consumer products), by capturing images or videos of the consumer products, by designating representative icons of the consumer products at an electronic display of consumer computer system 303 (FIG. 3), and/or by adding consumer products to an electronic shopping cart of a graphical user interface at an electronic display of consumer computer system 303 (FIG. 3). Consumer computer system 303 (FIG. 3) can provide the selections to central computer system 301 (FIG. 3) and/or commerce module 409 via communication module 411 for identification (e.g., recognition) of the selections by central computer system 301 (FIG. 3) and/or commerce module 409. In these or other embodiments, when selecting multiple consumer products, the consumer can select two or more of the consumer products serially and/or approximately simultaneously. Notably, as will be better understood with the context of information module 410 below, the consumer can also select suggested, alternative, and/or complimentary consumer products recommended by information module 410 via communication module 411. For example, in some embodiments, when the consumer selects two of more of the consumer products serially, a later selected consumer product can comprise an alternative and/or complimentary consumer product recommended by information module 410 as described below.

Meanwhile, in these or other embodiments, commerce module 409 can permit the consumer to electronically purchase and/or hold for later purchase the selected consumer products. Purchased consumer products can be delivered to the consumer or held for later pickup by the consumer. Further, when purchased from brick-and-mortar stores, the consumer can receive the consumer products immediately in person.

### Location Module 408

Location module 408 is operable to identify (e.g., determine) a consumer location of the consumer. The consumer location can refer to a physical location (e.g., a geographic location) of the consumer. In many embodiments, the consumer location can be represented using any suitable coordinate system (e.g., a latitude, longitude, and elevation coordinate system).

In many embodiments, central computer system 301 (FIG. 3) and/or location module 408 can receive the consumer location from consumer computer system 303 (FIG. 3) via communication module 411 to identify the consumer location. In some embodiments, the consumer can electronically input her location at consumer computer system 303 (FIG. 3), by one or more input devices (e.g., a keyboard, a mouse, a touch screen electronic display, a microphone, etc.) of consumer computer system 303 (FIG. 3), and consumer computer system 303 (FIG. 3) can provide the consumer location to central computer system 301 (FIG. 3) and/or location module 408. In other embodiments, consumer computer system 303 (FIG. 3) can detect the consumer location, such as, for example, using a navigation system (e.g., a global positioning system), and provide the detected consumer location to central computer system 301 (FIG. 3) and/or location module 408. In still other embodiments, consumer computer system 303 (FIG. 3) can provide a device identification number of consumer computer system 303 to central computer system 301 (FIG. 3) and/or location module 408, and central computer system 301 (FIG. 3) and/or location module 408 can identify (e.g., determine) the consumer location by association of the device identification number with one or more geographic regions and then by assuming the consumer location is within the geographic region(s). In these embodiments, the geographic region(s) associated with the device identification number can be established using any suitable scheme or schemes. For example, the billing address of a phone or data bill associated with consumer computer system 303 (FIG. 3) can be within a geographic region, an address of a store at which consumer computer system 303 (FIG. 3) was purchased can be within a geographic region, etc. and the device identification number can be associated with the geographic region(s). Exemplary geographic region(s) can comprise a country, a state, a county, a city, a zip code, a nearest cross street, etc.

Notably, some approaches for identifying the consumer location can be more accurate than others. For example, consumer location detection by consumer computer device 303 (FIG. 3) can be implemented where high accuracy is desirable because it may be more accurate than manual electronic input and/or device identification number association. Also, in some embodiments, location module 408 can implement multiple approaches to identify (e.g., determine) the consumer location. For example, location module 408 can attempt to use differing location identification approaches according to accuracy in descending order from most accurate to least accurate until the most accurate approach available successfully identifies the consumer location.

In many embodiments, the consumer location can be received at central computer system 301 (FIG. 3) and/or location module 408 in real-time or near real-time and/or at regular predetermined intervals, such as, for example, so that the consumer location identified is as currently accurate as possible. In some embodiments, such as, for example, when central computer system 301 (FIG. 3) and/or location module 408 receive a detected consumer location or a device identification number of consumer computer system 303 (FIG. 3), the consumer location and/or device identification number can be received automatically at central computer system 301 (FIG. 3) and/or location module 408 via communication module 411. Meanwhile, in other embodiments, central computer system 301 (FIG. 3) and/or location module 408 can prompt the consumer to provide the consumer location at consumer computer system 303 (FIG. 3) at the regular intervals or upon the occurrence of an event (e.g., selection of a consumer product as described above with respect to consumer module 409).

Meanwhile, in some embodiments, location module 408 can be operable to identify consumer product locations of the consumer products of the consumer products inventories corresponding to the brick-and-mortar store(s) discussed above with respect to commerce module 409. The consumer product locations can comprise physical locations (e.g., geographic locations) of these consumer products (e.g., within the respective brick-and-mortar store(s)). In many embodiments, the consumer product locations can be represented using any suitable coordinate system (e.g., a latitude, longitude, and elevation coordinate system).

In many embodiments, central computer system 301 (FIG. 3) and/or location module 408 can receive the consumer product locations via communication module 411 from consumer products database(s) 514 (FIG. 5). For example, in these embodiments, the inventory information of consumer products database(s) 514 (FIG. 5) can further comprise the consumer product locations. Meanwhile, in these or other embodiments, central computer system 301 (FIG. 3) and/or location module 408 can receive the consumer product locations via communication module 411 from consumer product location sensors (e.g., radio frequency identification tags) at the consumer products.

Also, location module 408 can be operable to identify the consumer location relative to two or more (e.g., each) of the consumer product locations. More particularly, in many embodiments, location module 408 can be operable to identify the consumer location relative to two or more (e.g., each) of the consumer product locations of the consumer products of a particular brick-and-mortar store where the consumer currently is located.

In some embodiments, in identifying the consumer location relative to the two or more (e.g., each) of the consumer product locations, location module 408 can determine a point-to-point distance (i.e., a shortest distance) between the consumer location and the two or more (e.g., each) of the consumer product locations. Meanwhile, in other embodiments, in identifying the consumer location relative to the two or more (e.g., each) of the consumer product locations, location module 408 can determine one or more walking distances and/or walking times between the consumer location and each of the two or more (e.g., each) of the consumer product locations. A walking distance can refer to a distance of a physical path between the consumer location and the particular consumer product location that accounts for the physical layout of the corresponding brick-and-mortar store having the consumer product corresponding to the consumer product location. Meanwhile, a walking time can refer to an estimated quantity of time to move between the consumer location and the particular consumer product location that accounts for the physical layout of the corresponding brick-and-mortar store having the consumer product corresponding to the consumer product location. For example, in accounting for the physical layout, location module 408 can factor the different floors of the particular brick-and-mortar store, modes of access (e.g., escalators, stairs, elevators, etc.), long term obstacles (e.g., exterior walls, aisle walls, freezers, checkout stands, etc.), and/or short term obstacles (e.g., temporary displays, etc.). As noted, in many embodiments, location module 408 can determine multiple walking distances or walking times for each of the two or more (e.g., each) of the consumer product locations. Further, location module 408 can identify the walking distance or walking time of those walking distances or walking times that is the shortest for the particular consumer product location. In order to account for the physical layout of the brick-and-mortar store of interest, location module 408 can receive physical layout information from floor plan database(s) 517 (FIG. 5) via communication module 411. The physical layout information can include the details about the physical layout factored by location module 408. In general, the relevance of identifying the consumer product location relative to the consumer product locations will be better understood in context with information module 410 (discussed below).

Further, in some embodiments, location module 408 can be operable to identify one or more geographic regions corresponding to the consumer location and one or more regional health characteristics associated with the geographic region(s). For example, central computer system 301 (FIG. 3) and/or location module 408 can receive, via communication module 411, these geographic region(s) corresponding to (e.g., including) the consumer location identified (as described above) by central computer system 301 (FIG. 3) and/or location module 408 from geographic regions database(s) 515 (FIG. 5). In these or other embodiments, central computer system 301 (FIG. 3) and/or location module 408 can receive via communication module 411 these regional health characteristic(s) from regional health characteristics database(s) 516 (FIG. 5).

A geographic region can refer to any defined area or region of the Earth. Exemplary geographic region(s) can include a country, a state, a county, a city, a zip code, a nearest cross street, etc. Meanwhile, a regional health characteristic can refer to any suitable health statistics relating to a geographic region. Exemplary regional health characteristic(s) can include a high incidence of a physical condition (e.g., obesity, hypertension, cholesterol, cancer, heart disease, or any other physical condition(s) as described above) in persons or animals (e.g., pets), such as, for example, in a geographic region as compared to an average incidence of the physical condition in comparable geographic regions (e.g., geographic regions of the same type). The definition of a high incidence can vary depending on the particular physical condition of interest but may be determined based on any suitable predetermined percentage incidence (e.g., one percent, two percent, five percent, ten percent, twenty percent, etc.) above or below the average. In some embodiments, the boundaries and/or types of geographic region(s) stored (e.g., indexed) at geographic regions database(s) 515 can be chosen based on current and/or known regional health characteristic(s) generally. The relevance of identifying the geographic region(s) and the corresponding regional health characteristic(s) will be better understood in context with information module 410 (discussed below).

Further still, in some embodiments, location module 408 can be operable to identify one or more weather conditions corresponding to the consumer location and one or more weather-related health characteristics associated with the weather condition(s). For example, central computer system 301 (FIG. 3) and/or location module 408 can receive, via communication module 411, these weather condition(s) corresponding to the consumer location identified (as described above) by central computer system 301 (FIG. 3) and/or location module 408 from weather conditions database(s) 518 (FIG. 5). In these or other embodiments, central computer system 301 (FIG. 3) and/or location module 408 can receive via communication module 411 these weather-related health characteristic(s) from weather-related health characteristics database(s) 519 (FIG. 5).

A weather condition can refer to a current and/or predicted condition of the atmosphere of the Earth. Exemplary weather condition(s) can include temperature, dew point, atmospheric pressure, precipitation, wind speed, wind direction, etc. Further, weather condition(s) can include air pollution (e.g., gas levels, particulate levels, etc.). Meanwhile, a weather-related health characteristic can be similar or identical to a regional health characteristic but as applied to a particular weather condition of the Earth as opposed to as applied to a region or area of the Earth. The relevance of identifying the weather condition(s) and the corresponding weather-based health health characteristic(s) will be better understood in context with information module 410 (discussed below).

### Information Module 410

Information module 410 is operable to determine consumer product information for one or more consumer products to communicate to the consumer. Accordingly, system 300 (FIG. 3) and/or information module 410 can advantageously inform (e.g., educate) the consumer about consumer products, such as, for example, when the consumer is making purchasing decisions. In particular, system 300 (FIG. 3) and/or information module 410 can help the consumer to select healthier options tailored to the specific health needs of the consumer, and/or when applicable, one or more consumer affiliated entities.

Information module 410 can proactively and/or reactively determine the consumer product information, as introduced previously above. In particular, in many embodiments, information module 410 can determine the consumer product information when commerce module 409 identifies (e.g., recognizes) the selection of the consumer product by the consumer, as discussed above. In these or other embodiments, information module 410 can determine the consumer product information to provide to the consumer regardless of the consumer products selected by the consumer. In other embodiments, information module 410 can determine the consumer product information to communicate to the consumer regardless of selections of consumer products by the consumer.

In some embodiments, central computer system 301 (FIG. 3) and/or information module 410 can consider one or more factors when determining the consumer product information. For example, in determining the consumer product information, central computer system 301 (FIG. 3) and/or information module 410 can consider: (i) part or all of the health profile information of the consumer (e.g., the consumer health code); (ii) part or all of the health profile information of one or more consumer affiliated entities of the consumer (e.g., one or more consumer affiliated entity health code(s)); (iii) the consumer location of the consumer relative to one or multiple consumer product locations (e.g., of the consumer products of a particular brick-and-mortar store); (iv) one or more regional health characteristics corresponding to one or more geographic regions associated with the consumer location of the consumer; (v) one or more weather-related health characteristics corresponding to one or more weather conditions associated with the consumer location of the consumer; and/or (vi) one or more currently and/or previously identified selections of consumer products. Previously identified selections can refer to earlier selections during a current transaction and/or earlier selections during a historic transaction. In many embodiments, when multiple factors are considered in determining the consumer product information, central computer system 301 (FIG. 3) and/or information module 410 can weigh the factors differently, with some factors being considered more important than others. However, in other embodiments, each of the factors can be given equal weight relative to each other. Meanwhile, information module 410 can communicate with health module 407, location module 408, and/or commerce module 409 via communication module 411 to obtain the relevant information needed when determining the consumer product information.

With respect to determining the consumer product information as it applies to (i) the health profile information of the consumer (e.g., the consumer health code) and/or (ii) the health profile information of one or more consumer affiliated entities of the consumer (e.g., one or more consumer affiliated entity health codes), in some embodiments, central computer system 301 (FIG. 3) and/or information module 410 can provide consumer product information that addresses one or more physical characteristics, one or more physical conditions, and/or one or more medical prescriptions of the consumer and/or the consumer affiliated entities in a manner that is conducive to the health of the consumer and/or the consumer affiliated entities. As introduced above, the advantage to the consumer of including or linking consumer affiliated entities with the consumer's profile can be that central computer system 301 (FIG. 3) and/or information module 410 can consider the health profile information of the consumer affiliated entities (e.g., the consumer affiliated entity health code(s)) in addition to the health profile information (e.g., consumer health code) of the consumer when determining the consumer product information. Notably, depending on the manner in which central computer system 301 (FIG. 3) and/or health module 407 organizes the consumer affiliated entity health profile(s) (e.g., consumer affiliated entity health code(s)) relative to the consumer health profile (e.g., consumer health code), central computer system 301 (FIG. 3) and/or information module 410 can operate in differing manners to determine the consumer product information. For example, when the consumer health code is determined (e.g., calculated) so that it includes the consumer affiliated entity health code(s), central computer system 301 (FIG. 3) and/or information module 410 can consider the consumer affiliated entity health code(s) indirectly through consideration of the consumer health code. However, when the consumer health code and the consumer affiliated entity health code(s) are maintained independently of each other, central computer system 301 (FIG. 3) and/or information module 410 can consider the consumer health code and the consumer affiliated entity health code(s) independently. Meanwhile, to the extent there are no consumer affiliated entities include with or linked with the consumer health profile, central computer system 301 (FIG. 3) and/or information module 410 can determine the consumer product information without any consideration of the health profile information of one or more consumer affiliated entities of the consumer (e.g., one or more consumer affiliated entity health code(s)).

Further, with respect to determining the consumer product information as it applies to the consumer location of the consumer relative to two or more consumer product locations (e.g., of the consumer products of a particular brick-and-mortar store), in some embodiments, central computer system 301 (FIG. 3) and/or information module 410 can provide consumer product information that favors those consumer products that are most easily accessible (e.g., nearest by point-to-point distance and/or walking distance) to the consumer. Further still, with respect to determining (i) one or more regional health characteristics corresponding to one or more geographic regions associated with the consumer location of the consumer and/or (ii) one or more weather-related health characteristics corresponding to one or more weather conditions associated with the consumer location of the consumer, in some embodiments, central computer system 301 (FIG. 3) and/or information module 410 can provide consumer product information that addresses the relevant regional health characteristic(s) and/or the weather-related health characteristic(s) in a manner that is conducive to the health of the consumer and/or the consumer affiliated entities.

In some embodiments, the consumer product information can comprise an alert regarding the consumer product. In many embodiments, central computer system 301 (FIG. 3) and/or information module 410 can provide consumer product information comprising an alert when determining the consumer product information reactively. In particular, the alert can comprise an indication that a consumer product identified as selected by commerce module 409 conflicts with one or more of the physical characteristic(s), one or more of the physical condition(s), one or more of the medical prescription(s), and/or one or more of the health goal(s) of the consumer and/or the one or more consumer affiliated entities. For example, if the consumer health profile (e.g., consumer health code) and/or the consumer affiliated entity health profile(s) (e.g., consumer affiliated entity health code(s)) indicate that the consumer or one of the consumer affiliated entities has the physical condition of diabetes and the consumer selects cookies as the consumer product, central computer system 301 (FIG. 3) and/or information module 410 can determine that the consumer product information should include an alert that the cookies conflict with the physical condition of diabetes. Meanwhile, in these or other examples, if the consumer location were to correspond to one or more geographic regions and/or one or more weather condition(s) corresponding to regional health characteristic(s) and/or weather-related health characteristic(s) associating a high incidence of diabetes therewith, central computer system 301 (FIG. 3) and/or information module 410 can also determine that the consumer product information should include an alert of such conflict(s). In other similar examples, the consumer product could comprise a prescription or over-the-counter medication or another consumer product (e.g., alcohol) that has a known adverse reaction with one or more existing medical prescriptions of the consumer and/or one of the consumer affiliated entities, as determined from the medical prescription(s) of the consumer health profile (e.g., consumer health code) and/or the consumer affiliated entity health profile(s) (e.g., consumer affiliated entity health code(s)). Thus, central computer system 301 (FIG. 3) and/or information module 410 can determine that the consumer product information should include an alert of this conflict. In further similar examples, a first identified consumer product can comprise candy and a second identified consumer product can comprise weight loss pills, in which case central computer system 301 (FIG. 3) and/or information module 410 can determine that the consumer product information should include an alert of a conflict in these selected consumer products. In still further similar examples, an identified consumer product can comprise candy, alcohol, etc., and the consumer health profile (e.g., consumer health code) and/or the consumer affiliated entity health profile(s) (e.g., consumer affiliated entity health code(s)) may not indicate any expressed conflicts with the consumer product, but central computer system 301 (FIG. 3) and/or information module 410 can determine that the consumer product information should include an alert because the identified consumer product is known to be unhealthy for consumption.

In these or other embodiments, the consumer product information can comprise (i) consumer product statistics of the consumer product and/or one or more other consumer products and/or (ii) a suggestion of one or more consumer products (e.g., one or more complimentary consumer products and/or one or more alternative consumer products). Consumer product statistics can refer to any factual information about the consumer product. Exemplary product statistics can include calories, fat, carbohydrate, sugar, and/or sodium content, grams of protein, ingredients, etc., such as, for example, when the consumer product is a nutritional consumer product. In many embodiments, a complimentary consumer product can refer to a consumer product that compliments a selected consumer product that is identified. For example, complimentary consumer products can comprise two vitamins that are commonly taken together. Meanwhile, an alternative consumer product can refer to a consumer product that can replace the selected consumer product identified. For example, an alternative consumer product can comprise fruit instead of candy.

In many embodiments, central computer system 301 (FIG. 3) and/or information module 410 can determine that the consumer product information should include the suggestion of complimentary consumer product(s) and/or alternative consumer product(s) when central computer system 301 (FIG. 3) and/or information module 410 determined the consumer product information reactively. In some embodiments, central computer system 301 (FIG. 3) and/or information module 410 can determine that the consumer product information should include the consumer product statistic(s) when central computer system 301 (FIG. 3) and/or information module 410 determined the consumer product information reactively. For example, comparisons of consumer product statistics can illustrate why a consumer product may not be health for the consumer. Notably, in some embodiments, the consumer product statistics and/or the suggestion of the consumer product(s) can be provided along with consumer product information including one or more alerts, or separately. Further, in some embodiments, the consumer product statistics and/or the suggestion of the consumer product(s) can be provided as part of one or more alerts. Also, in many embodiments, central computer system 301 (FIG. 3) and/or information module 410 can determine that the consumer product information should include (i) consumer product statistics of the consumer product and/or one or more other consumer products and/or (ii) a suggestion of one or more consumer products when central computer system 301 (FIG. 3) and/or information module 410 determined the consumer product information proactively. For example, in a proactive application, central computer system 301 (FIG. 3) and/or information module 410 can determine the consumer product information should include a suggestion of oatmeal when the consumer and/or one of the consumer affiliated entities is determined to have high cholesterol based on the consumer health profile (e.g., consumer health code) and/or the consumer affiliated entity health profile(s) (e.g., consumer affiliated entity health code(s)). In these embodiments, the consumer product information can function more closely as a solicitation of the consumer to purchase one or more particular consumer products.

Regardless of whether the applications are proactive or reactive, central computer system 301 (FIG. 3) and/or information module 410 can consider one or more of the factors outlined above for determining the consumer product information. In many embodiments, central computer system 301 (FIG. 3) and/or information module 410 can consider the consumer location of the consumer relative to one or more consumer product locations (e.g., of the consumer products of a particular brick-and-mortar store) when determining suggestions of consumer products as part of the consumer product information. For example, central computer system 301 (FIG. 3) and/or information module 410 can determine to suggest one consumer product over one or more others because the particular consumer product is more easily accessible to the consumer. In other examples, central computer system 301 (FIG. 3) and/or information module 410 can determine to suggest a consumer product because the consumer is near the consumer product generally.

Further, when available, central computer system 301 (FIG. 3) and/or information module 410 can consider financial information of the consumer health profile and/or one or more consumer affiliated entity health profiles when determining suggestions of consumer products as part of the consumer product information. For example, central computer system 301 (FIG. 3) and/or information module 410 can determine to suggest one consumer product over one or more others (e.g., a generic drug over a name brand drug) because it is cheaper for a consumer having a first income but to suggest the name brand for another consumer having a higher income. Meanwhile, central computer system 301 (FIG. 3) and/or information module 410 can determine to suggest one consumer product over one or more others because it is covered by the consumer's insurance plan and the others are not.

Information module 410 is further operable to communicate the consumer product information to the consumer. For example, central computer system 301 (FIG. 3) and/or information module 410 can provide the consumer product information to consumer computer system 303 (FIG. 3) via communication module 411. The consumer can indicate to central computer system 301 (FIG. 3) and/or information module 410 her preference on how central computer system 301 (FIG. 3) and/or information module 410 provide the consumer product information. For example, the consumer product information can be provided to the consumer by email, text message, telephone call, an audio clip, a video, etc. Further, the consumer product information can be displayed at a web browser or at a mobile application.

In some embodiments, the consumer product information can be provided near a selected consumer product at a graphical user interface of a web browser or a mobile application displaying the selected consumer product. For example, when the consumer product information comprises an alert, the alert can be provided as yellow icon (e.g., a flag) which the consumer can recognize as the alert. In some embodiments, the alert can include an alert sound. In these or other embodiments, central computer system 301 (FIG. 3) and/or information module 410 can be configured such that the consumer can elect how the alerts are provided. For example, the consumer may want to see the yellow icon but not receive the alert sound, or vice versa. Further, in some embodiments, with repeat violations, central computer system 301 (FIG. 3) and/or information module 410 can modify the alert to indicate the repeat offenses, such as, for example, changing the color of the icon, the noise, the volume of the noise, etc. In these or other embodiments, central computer system 301 (FIG. 3) and/or information module 410 can permit the consumer to select the alert to provide additional information on the reason for the alert. In some embodiments, the consumer product information can further include contact information if the consumer wants to contact a person regarding an alert, a consumer product suggestion, consumer product statistics, etc. For example, the contact information can include contact information for a pharmacist.

Meanwhile, in many embodiments, central computer system 301 (FIG. 3) and/or information module 410 can be configured to permit the consumer to ask to receive consumer product information from central computer system 301 (FIG. 3) and/or information module 410. Further, the consumer can indicate the extent of the consumer product information she desires to receive. For example, in some embodiments, the consumer can indicate a preference to receive only consumer product information regarding nutritional consumer products and/or pharmacological consumer products. Meanwhile, in these or other embodiments, preferences can be even more granular, such as, for example, a preference to receive only consumer product information regarding one or more types of nutritional consumer products (e.g., produce, deli, bakery, etc.) and/or one or more types of pharmacological consumer products (e.g., prescription medications, over the counter medications, etc.). In this manner, the consumer can limit the quantity of information to an amount she finds comfortable.

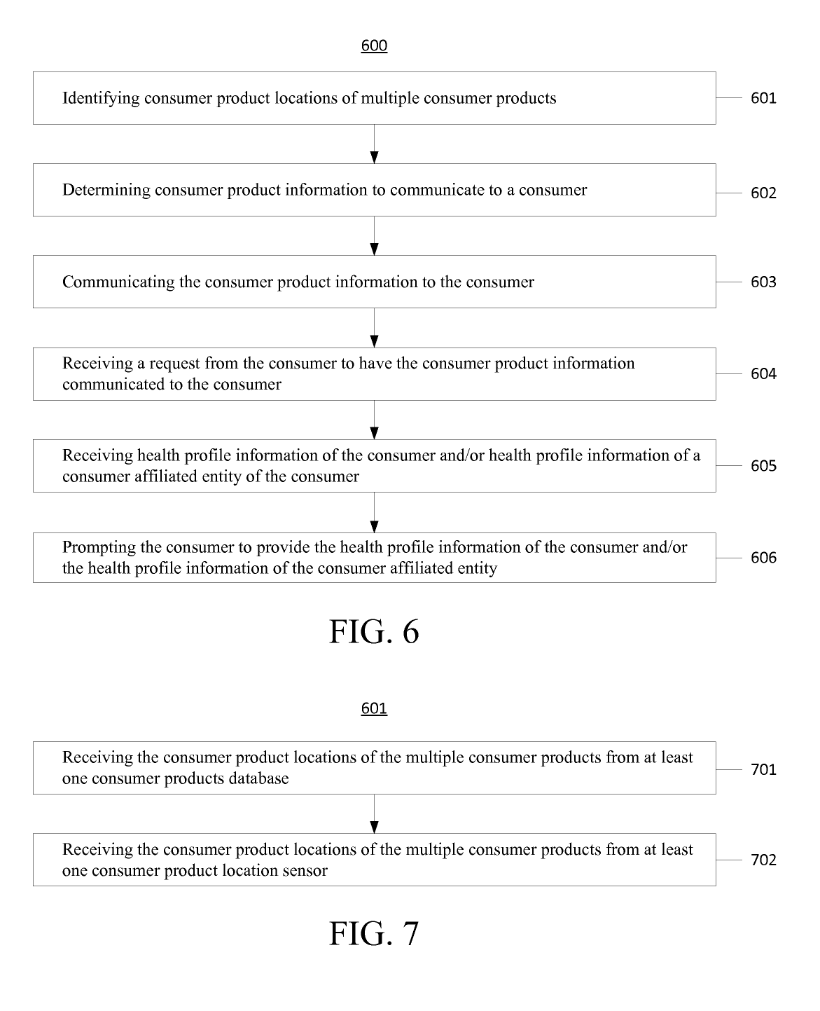

Turning ahead in the drawings, FIG. 6 illustrates a flow chart for a method 600, according to an embodiment. Method 600 is merely exemplary and is not limited to the embodiments presented herein. Method 600 can be employed in many different embodiments or examples not specifically depicted or described herein. In some embodiments, the activities of method 600 can be performed in the order presented. In other embodiments, the activities of method 600 can be performed in any suitable order. In still other embodiments, one or more of the activities of method 600 can be combined or skipped. In many embodiments, central computer system 301 (FIG. 3) can be suitable to perform method 600 and/or one or more of the activities of method 600. In these or other embodiments, one or more of the activities of method 600 can be implemented as one or more computer instructions configured to run at one or more processing modules and configured to be stored at one or more non-transitory memory storage modules. The processing module(s) can be similar or identical to the processing module(s) described above with respect to computer system 100 (FIG. 1) and/or to processing module(s) 404 (FIG. 4). Further, the non-transitory memory storage module(s) can be similar or identical to the non-transitory memory storage module(s) described above with respect to computer system 100 (FIG. 1) and/or to non-transitory memory storage module(s) 406 (FIG. 4).

Method 600 can comprise activity 601 of identifying consumer product locations of multiple consumer products. In some embodiments, performing activity 601 can be similar or identical to identifying consumer product locations of multiple consumer products as described above with respect to system 300 (FIG. 3) and/or location module 408 (FIG. 4). Further, the consumer product locations can be similar to the consumer product locations described above with respect to system 300 (FIG. 3); and/or the multiple consumer products can be similar or identical to the consumer products described above with respect to system 300 (FIG. 3). FIG. 7 illustrates an exemplary activity 601, according to the embodiment of FIG. 6.

For example, activity 601 can comprise activity 701 of receiving the consumer product locations of the multiple consumer products from at least one consumer products database. In some embodiments, the consumer product database(s) can be similar or identical to consumer product database(s) 514 (FIG. 5).

Further, activity 601 can comprise activity 702 of receiving the consumer product locations of the multiple consumer products from at least one consumer product location sensor. In some embodiments, the consumer product location sensor(s) can be similar or identical to the consumer product location sensor(s) described above with respect to system 300 (FIG. 3) and/or location module 408 (FIG. 4). In some embodiments, when activity 701 is performed, activity 702 can be omitted, and vice versa.

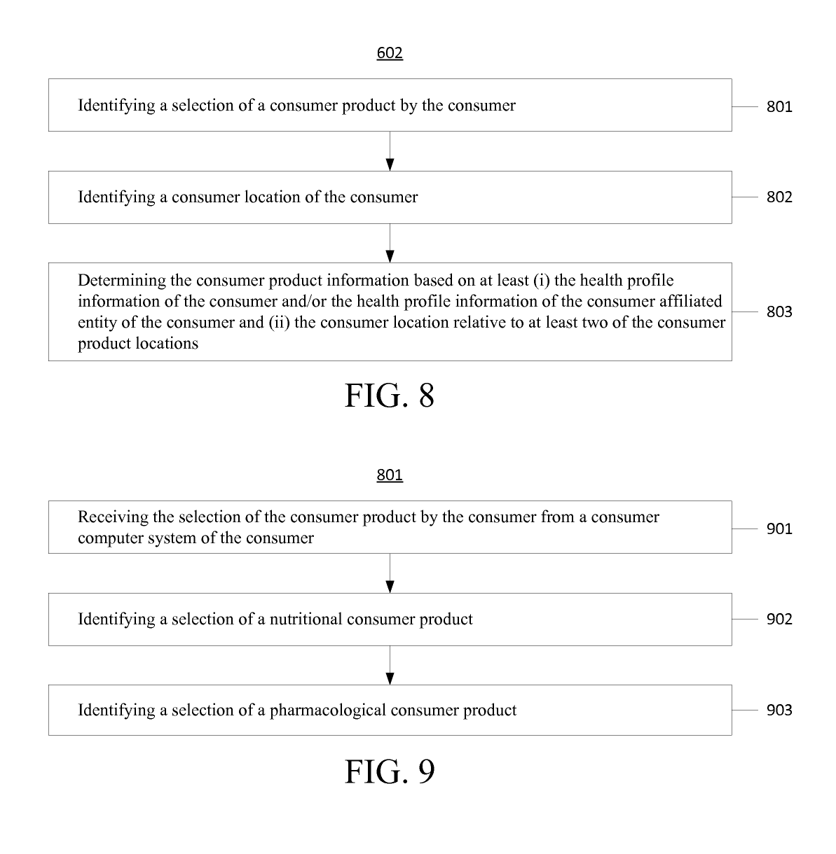

Returning now to FIG. 6, method 600 can comprise activity 602 of determining consumer product information to communicate to a consumer. In some embodiments, performing activity 602 can be similar or identical to determining consumer product information to communicate to a consumer as described above with respect to system 300 (FIG. 3) and/or location module 408 (FIG. 4). Further, the consumer can be similar or identical to the consumer described above with respect to system 300 (FIG. 3); and/or the consumer product information can be similar or identical to the consumer product information described above with respect to system 300 (FIG. 3). FIG. 8 illustrates an exemplary activity 602, according to the embodiment of FIG. 6.

For example, activity 602 can comprise activity 801 of identifying a selection of a consumer product by the consumer. In these embodiments, the multiple consumer products can include the consumer product. Further, in these or other embodiments, performing activity 801 can be similar or identical to identifying a selection of a consumer product by the consumer as described above with respect to system 300 (FIG. 3) and/or commerce module 409 (FIG. 4). FIG. 9 illustrates an exemplary activity 801, according to the embodiment of FIG. 6.

For example, activity 801 can comprise activity 901 of receiving the selection of the consumer product by the consumer from a consumer computer system of the consumer. In many embodiments, the consumer computer system can be similar or identical to any of consumer computer system(s) 302 (FIG. 3) and/or to consumer computer system 303 (FIG. 3).

Further, activity 801 can comprise activity 902 of identifying a selection of a nutritional consumer product. In many embodiments, the nutritional consumer product can be similar or identical to the nutritional consumer product described above with respect to system 300 (FIG. 3) and/or commerce module 409 (FIG. 4). In some embodiments, activity 902 can be performed as part of activity 901.

Further still, activity 801 can comprise activity 903 of identifying a selection of a pharmacological consumer product. In many embodiments, the pharmacological consumer product can be similar or identical to the pharmacological consumer product described above with respect to system 300 (FIG. 3) and/or commerce module 409 (FIG. 4). In some embodiments, activity 903 can be performed as part of activity 901. In further embodiments, when activity 902 is performed, activity 903 can be omitted, and vice versa.

Returning to FIG. 8, activity 602 can comprise activity 802 of identifying a consumer location of the consumer. In these embodiments, performing activity 802 can be similar or identical to identifying a consumer location of the consumer as described above with respect to system 300 (FIG. 3) and/or location module 408 (FIG. 4). For example, in some embodiments, performing activity 802 can comprise an activity of receiving the consumer location of the consumer from the consumer computer system. Further, the consumer computer system can be configured to detect the consumer location of the consumer, such as, for example, as described above with respect to system 300 (FIG. 3) and/or location module 408 (FIG. 4).

Also, activity 602 can comprise activity 803 of determining the consumer product information based on at least (i) health profile information of the consumer and/or health profile information of a consumer affiliated entity of the consumer and (ii) the consumer location relative to at least two of the consumer product locations. In many embodiments, the health profile information of the consumer can be similar or identical to the health profile information of the consumer as described above with respect to system 300 (FIG. 3) and/or health module 407 (FIG. 4); and/or the health profile information of the consumer affiliated entity can be similar or identical to any of the health profile information of the one or more consumer affiliated entities as described above with respect to system 300 (FIG. 3) and/or health module 407 (FIG. 4). Further, performing activity 803 can be similar or identical to determining the consumer product information based on at least (i) health profile information of the consumer and/or health profile information of a consumer affiliated entity of the consumer and (ii) the consumer location relative to at least two of the consumer product locations as described above with respect to system 300 (FIG. 3) and/or information module 410 (FIG. 4). In many embodiment, activity 802 can be performed after activity 801, and/or activity 803 can be performed after activity 801 and/or activity 802.

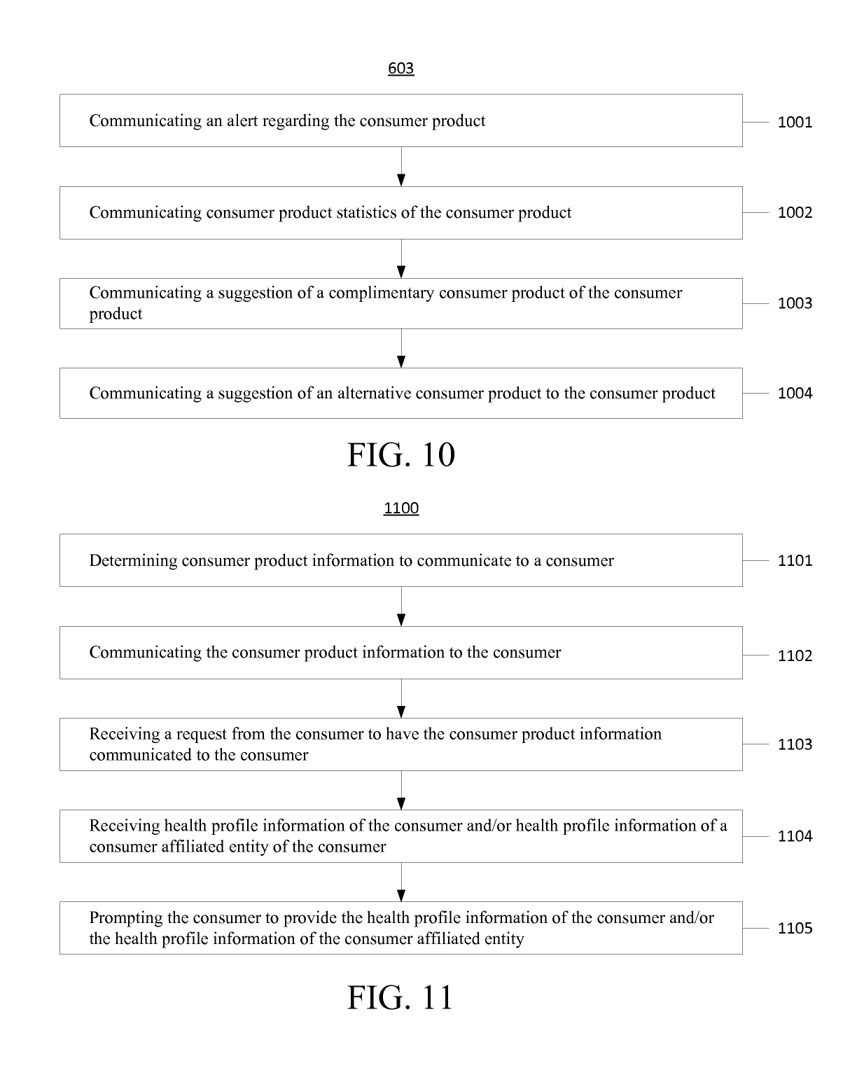

Returning now to FIG. 6, method 600 can comprise activity 603 of communicating the consumer product information to the consumer. In many embodiments, performing activity 603 can be similar or identical to communicating the consumer product information to the consumer as described above with respect to system 300 (FIG. 3). Generally, activity 603 can be performed after activity 601 and activity 602. FIG. 10 illustrates an exemplary activity 603, according to the embodiment of FIG. 6.

For example, activity 603 can comprise activity 1001 of communicating an alert regarding the consumer product. In these embodiments, the consumer product information can include the alert, and the alert can be similar or identical to the alert described above with respect to system 300 (FIG. 3) and/or information module 410 (FIG. 4).

Further, activity 603 can comprise activity 1002 of communicating consumer product statistics of the consumer product. In these embodiments, the consumer product information can include the consumer product statistics, and the consumer product statistics can be similar or identical to the consumer product statistics described above with respect to system 300 (FIG. 3) and/or information module 410 (FIG. 4).

Further still, activity 603 can comprise activity 1003 of communicating a suggestion of a complimentary consumer product of the consumer product. In these embodiments, the consumer product information can include the suggestion of the complimentary consumer product, and the multiple consumer products can include the complimentary consumer product. Further, the complimentary product can be similar or identical to the complimentary product described above with respect to system 300 (FIG. 3) and/or information module 410 (FIG. 4).

Even further still, activity 603 can comprise activity 1004 of communicating a suggestion of an alternative consumer product to the consumer product. In these embodiments, the consumer product information can include the suggestion of the alternative consumer product, and the multiple consumer products can include the alternative consumer product. Further, the alternative consumer product can be similar or identical to the alternative consumer product described above with respect to system 300 (FIG. 3) and/or information module 410 (FIG. 4).

Returning again to FIG. 6, method 600 can comprise activity 604 of receiving a request from the consumer to have the consumer product information communicated to the consumer. In many embodiments, performing activity 604 can be similar or identical to receiving a request from the consumer to have the consumer product information communicated to the consumer as described above with respect to system 300 (FIG. 3) and/or information module 410 (FIG. 4). In some embodiments, activity 604 can be omitted. In many embodiments, activity 604 can be performed before one or more of activities 601-603.

Further, method 600 can comprise activity 605 of receiving the health profile information of the consumer and/or the health profile information of the consumer affiliated entity. In many embodiments, performing activity 605 can comprise receiving the health profile information of the consumer and/or the health profile information of the consumer affiliated entity as described above with respect to system 300 (FIG. 3) and/or health module 407 (FIG. 4). In many embodiments, activity 605 can be performed before one or more of activities 601-604.

Also, method 600 can comprise activity 606 of prompting the consumer to provide the health profile information of the consumer and/or the health profile information of the consumer affiliated entity. In many embodiments, performing activity 605 can comprise prompting the consumer to provide the health profile information of the consumer and/or the health profile information of the consumer affiliated entity as described above with respect to system 300 (FIG. 3) and/or health module 407 (FIG. 4). In some embodiments, activity 606 can be performed prior to activity 605. In other embodiments, activity 606 can be omitted. In many embodiments, activity 606 can be performed before one or more of activities 601-604.

In many embodiments, one or more of activities 601-604 (and/or one or more sub-activities thereof) can be repeated one or more times for one or more other consumer products (e.g., a second consumer product). In some embodiments, the other consumer product(s) (e.g., the second consumer product) can comprise the alternative or complimentary consumer product recommended at activity 1003 (FIG. 10) and/or activity 1004 (FIG. 10). In further embodiments, activity 605 and/or activity 606 (and/or one or more sub-activities thereof) can be repeated one or more times, such as, for example, as the consumer updates the health profile information of the consumer and/or the one or more consumer affiliated entities.

Turning ahead in the drawings, FIG. 11 illustrates a flow chart for a method 1100, according to an embodiment. Method 1100 is merely exemplary and is not limited to the embodiments presented herein. Method 1100 can be employed in many different embodiments or examples not specifically depicted or described herein. In some embodiments, the activities of method 1100 can be performed in the order presented. In other embodiments, the activities of method 1100 can be performed in any suitable order. In still other embodiments, one or more of the activities of method 1100 can be combined or skipped. In many embodiments, central computer system 301 (FIG. 3) can be suitable to perform method 1100 and/or one or more of the activities of method 1100. In these or other embodiments, one or more of the activities of method 1100 can be implemented as one or more computer instructions configured to run at one or more processing modules and configured to be stored at one or more non-transitory memory storage modules. The processing module(s) can be similar or identical to the processing module(s) described above with respect to computer system 100 (FIG. 1) and/or to processing module(s) 404 (FIG. 4). Further, the non-transitory memory storage module(s) can be similar or identical to the non-transitory memory storage module(s) described above with respect to computer system 100 (FIG. 1) and/or to non-transitory memory storage module(s) 406 (FIG. 4).

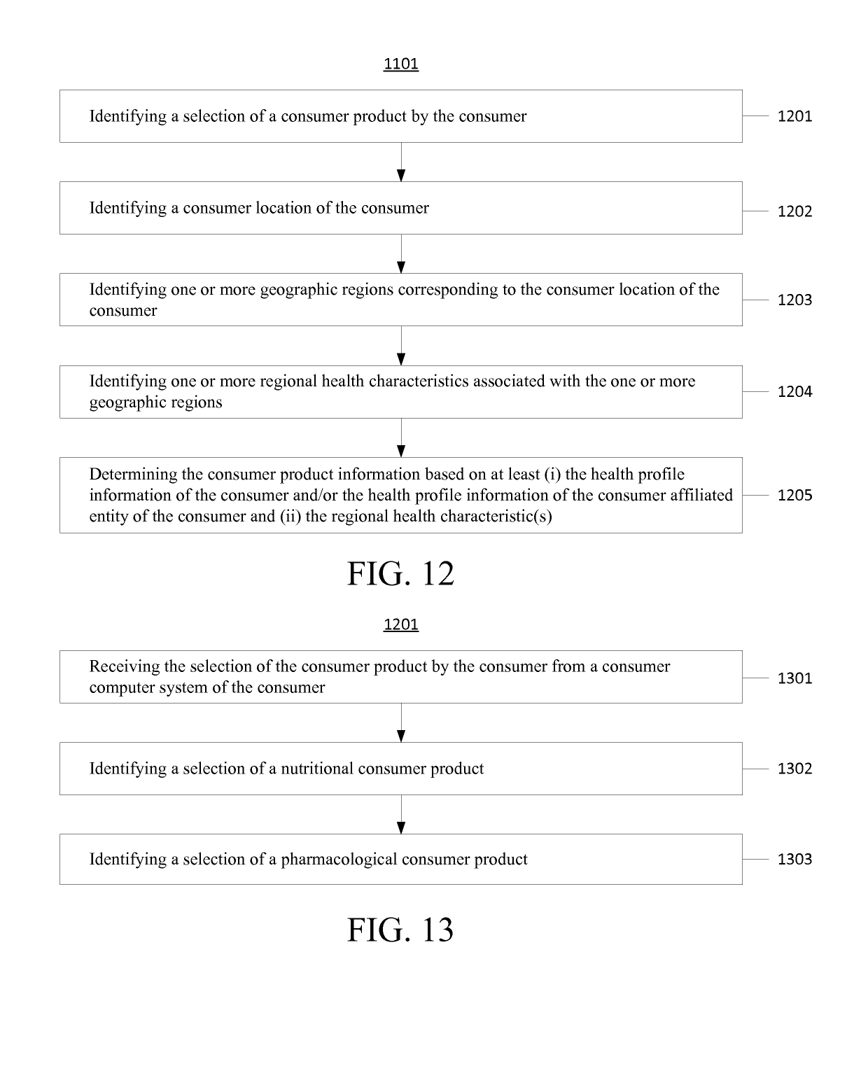

Method 1100 can comprise activity 1101 of determining consumer product information to communicate to a consumer. In some embodiments, performing activity 1101 can be similar or identical to determining consumer product information to communicate to a consumer as described above with respect to system 300 (FIG. 3) and/or location module 408 (FIG. 4). Further, the consumer can be similar or identical to the consumer described above with respect to system 300 (FIG. 3); and/or the consumer product information can be similar or identical to the consumer product information described above with respect to system 300 (FIG. 3). FIG. 12 illustrates an exemplary activity 1101, according to the embodiment of FIG. 11.

For example, activity 1101 can comprise activity 1201 of identifying a selection of a consumer product by the consumer. In these embodiments, the multiple consumer products can include the consumer product. Further, in these or other embodiments, performing activity 1201 can be similar or identical to identifying a selection of a consumer product by the consumer as described above with respect to system 300 (FIG. 3) and/or commerce module 409 (FIG. 4). FIG. 13 illustrates an exemplary activity 1201, according to the embodiment of FIG. 11.

For example, activity 1201 can comprise activity 1301 of receiving the selection of the consumer product by the consumer from a consumer computer system of the consumer. In many embodiments, the consumer computer system can be similar or identical to any of consumer computer system(s) 302 (FIG. 3) and/or to consumer computer system 303 (FIG. 3).

Further, activity 1201 can comprise activity 1302 of identifying a selection of a nutritional consumer product. In many embodiments, the nutritional consumer product can be similar or identical to the nutritional consumer product described above with respect to system 300 (FIG. 3) and/or commerce module 409 (FIG. 4). In some embodiments, activity 1302 can be performed as part of activity 1301.

Further still, activity 1201 can comprise activity 1303 of identifying a selection of a pharmacological consumer product. In many embodiments, the pharmacological consumer product can be similar or identical to the pharmacological consumer product described above with respect to system 300 (FIG. 3) and/or commerce module 409 (FIG. 4). In some embodiments, activity 1303 can be performed as part of activity 1301. In further embodiments, when activity 1302 is performed, activity 1303 can be omitted, and vice versa.

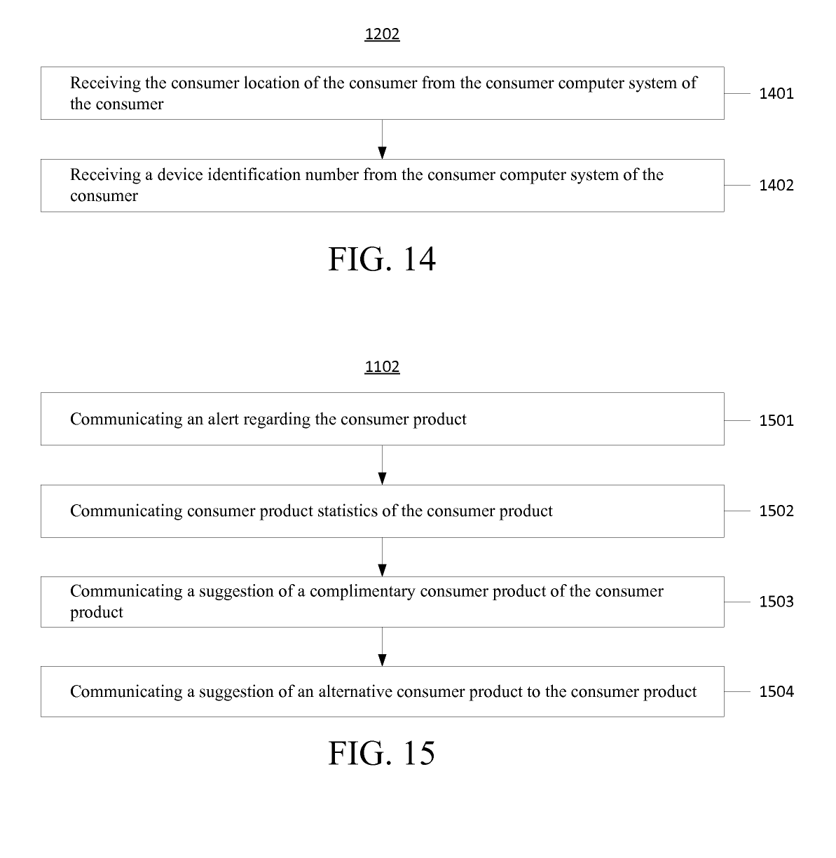

Turning back to FIG. 12, activity 1101 can comprise activity 1202 of identifying a consumer location of the consumer. In these embodiments, performing activity 1202 can be similar or identical to identifying a consumer location of the consumer as described above with respect to system 300 (FIG. 3) and/or location module 408 (FIG. 4). FIG. 14 illustrates an exemplary activity 1202, according to the embodiment of FIG. 11.

For example, activity 1202 can comprise activity 1401 of receiving the consumer location of the consumer from the consumer computer system. Further, the consumer computer system can be configured to detect the consumer location of the consumer, such as, for example, as described above with respect to system 300 (FIG. 3) and/or location module 408 (FIG. 4).

Further, activity 1202 can comprise activity 1402 of receiving a device identification number from the consumer computer system of the consumer. The device identification number can be similar or identical to the device identification number described above with respect to system 300 (FIG. 3) and/or location module 408 (FIG. 4). In some embodiments, when activity 1401 is performed, activity 1402 can be omitted, and vice versa.

Returning again to FIG. 12, activity 1101 can comprise activity 1203 of identifying one or more geographic regions corresponding to the consumer location of the consumer. The geographic region(s) can be similar or identical to the geographic region(s) described above with respect to system 300 (FIG. 3) and/or location module 408 (FIG. 4). In some embodiments, performing activity 1203 can comprise an activity of receiving the geographic region(s) corresponding to the consumer location of the consumer from at least one geographic regions database. In these embodiments, the geographic regions database(s) can be similar or identical to geographical regions database(s) 515 (FIG. 5).

Further, activity 1101 can comprise activity 1204 of identifying one or more regional health characteristics associated with the one or more geographic regions. The regional health characteristic(s) can be similar or identical to the regional health characteristic(s) described above with respect to system 300 (FIG. 3) and/or location module 408 (FIG. 4). In some embodiments, performing activity 1204 can comprise an activity of receiving the regional health characteristic(s) associated with the geographic region(s) from at least one regional health characteristics database. In these embodiments, the regional health characteristics database(s) can be similar or identical to regional health characteristics database(s) 516 (FIG. 5).

Further still, activity 1101 can comprise activity 1205 of determining the consumer product information based on at least (i) health profile information of the consumer and/or health profile information of a consumer affiliated entity of the consumer and (ii) the regional health characteristic(s). In many embodiments, the health profile information of the consumer can be similar or identical to the health profile information of the consumer as described above with respect to system 300 (FIG. 3) and/or health module 407 (FIG. 4); and/or the health profile information of the consumer affiliated entity can be similar or identical to any of the health profile information of the one or more consumer affiliated entities as described above with respect to system 300 (FIG. 3) and/or health module 407 (FIG. 4). Further, performing activity 803 can be similar or identical to determining the consumer product information based on at least (i) health profile information of the consumer and/or health profile information of a consumer affiliated entity of the consumer and (ii) the regional health characteristic(s) as described above with respect to system 300 (FIG. 3) and/or information module 410 (FIG. 4). In many embodiment, one or more of activities 1202-1205 can be performed after activity 1201. Further, one or more of activities 1202-1204 can be performed before activity 1205.

Returning now to FIG. 11, method 1100 can comprise activity 1102 of communicating the consumer product information to the consumer. In many embodiments, performing activity 1102 can be similar or identical to communicating the consumer product information to the consumer as described above with respect to system 300 (FIG. 3). Generally, activity 1102 can be performed after activity 1101. FIG. 15 illustrates an exemplary activity 1102, according to the embodiment of FIG. 11.

For example, activity 1102 can comprise activity 1501 of communicating an alert regarding the consumer product. In these embodiments, the consumer product information can include the alert, and the alert can be similar or identical to the alert described above with respect to system 300 (FIG. 3) and/or information module 410 (FIG. 4).

Further, activity 1102 can comprise activity 1502 of communicating consumer product statistics of the consumer product. In these embodiments, the consumer product information can include the consumer product statistics, and the consumer product statistics can be similar or identical to the consumer product statistics described above with respect to system 300 (FIG. 3) and/or information module 410 (FIG. 4).

Further still, activity 1102 can comprise activity 1503 of communicating a suggestion of a complimentary consumer product of the consumer product. In these embodiments, the consumer product information can include the suggestion of the complimentary consumer product, and the multiple consumer products can include the complimentary consumer product. Further, the complimentary product can be similar or identical to the complimentary product described above with respect to system 300 (FIG. 3) and/or information module 410 (FIG. 4).

Even further still, activity 1102 can comprise activity 1504 of communicating a suggestion of an alternative consumer product to the consumer product. In these embodiments, the consumer product information can include the suggestion of the alternative consumer product, and the multiple consumer products can include the alternative consumer product. Further, the alternative consumer product can be similar or identical to the alternative consumer product described above with respect to system 300 (FIG. 3) and/or information module 410 (FIG. 4).

Returning again to FIG. 11, method 1100 can comprise activity 1103 of receiving a request from the consumer to have the consumer product information communicated to the consumer. In many embodiments, performing activity 1103 can be similar or identical to receiving a request from the consumer to have the consumer product information communicated to the consumer as described above with respect to system 300 (FIG. 3) and/or information module 410 (FIG. 4). In some embodiments, activity 1103 can be omitted. In many embodiments, activity 1103 can be performed before one or more of activities 1101 and 1102.

Further, method 1100 can comprise activity 1104 of receiving the health profile information of the consumer and/or the health profile information of the consumer affiliated entity. In many embodiments, performing activity 1104 can comprise receiving the health profile information of the consumer and/or the health profile information of the consumer affiliated entity as described above with respect to system 300 (FIG. 3) and/or health module 407 (FIG. 4). In many embodiments, activity 1104 can be performed before one or more of activities 1101-1103.

Also, method 1100 can comprise activity 1105 of prompting the consumer to provide the health profile information of the consumer and/or the health profile information of the consumer affiliated entity. In many embodiments, performing activity 605 can comprise prompting the consumer to provide the health profile information of the consumer and/or the health profile information of the consumer affiliated entity as described above with respect to system 300 (FIG. 3) and/or health module 407 (FIG. 4). In some embodiments, activity 1105 can be performed prior to activity 1104. In other embodiments, activity 1105 can be omitted. In many embodiments, activity 1105 can be performed before one or more of activities 1101-1104.

In many embodiments, one or more of activities 1101-1103 (and/or one or more sub-activities thereof) can be repeated one or more times for one or more other consumer products (e.g., a second consumer product). In some embodiments, the other consumer product(s) (e.g., the second consumer product) can comprise the suggested consumer product recommended at activity 1503 (FIG. 10) and/or activity 1504 (FIG. 10). In further embodiments, activity 1104 and/or activity 1105 (and/or one or more sub-activities thereof) can be repeated one or more times, such as, for example, as the consumer updates the health profile information of the consumer and/or the one or more consumer affiliated entities.

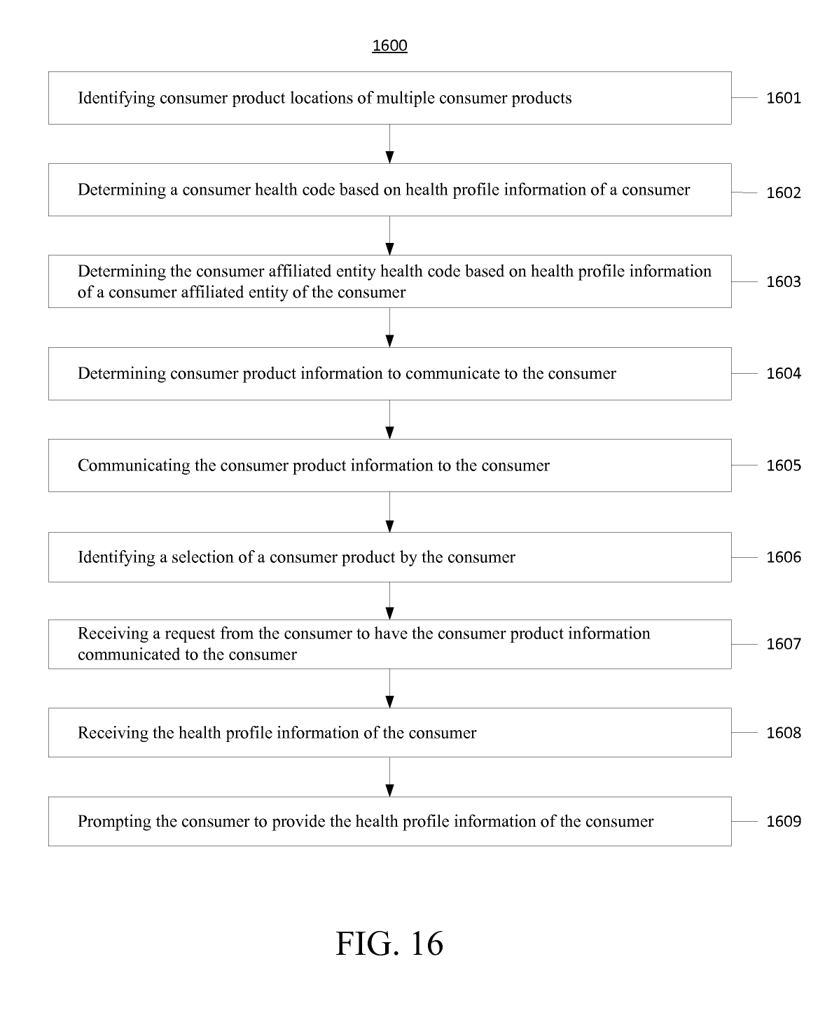

Turning ahead in the drawings, FIG. 16 illustrates a flow chart for a method 1600, according to an embodiment. Method 1600 is merely exemplary and is not limited to the embodiments presented herein. Method 1600 can be employed in many different embodiments or examples not specifically depicted or described herein. In some embodiments, the activities of method 1600 can be performed in the order presented. In other embodiments, the activities of method 1600 can be performed in any suitable order. In still other embodiments, one or more of the activities of method 1600 can be combined or skipped. In many embodiments, central computer system 301 (FIG. 3) can be suitable to perform method 1600 and/or one or more of the activities of method 1600. In these or other embodiments, one or more of the activities of method 1600 can be implemented as one or more computer instructions configured to run at one or more processing modules and configured to be stored at one or more non-transitory memory storage modules. The processing module(s) can be similar or identical to the processing module(s) described above with respect to computer system 100 (FIG. 1) and/or to processing module(s) 404 (FIG. 4). Further, the non-transitory memory storage module(s) can be similar or identical to the non-transitory memory storage module(s) described above with respect to computer system 100 (FIG. 1) and/or to non-transitory memory storage module(s) 406 (FIG. 4).

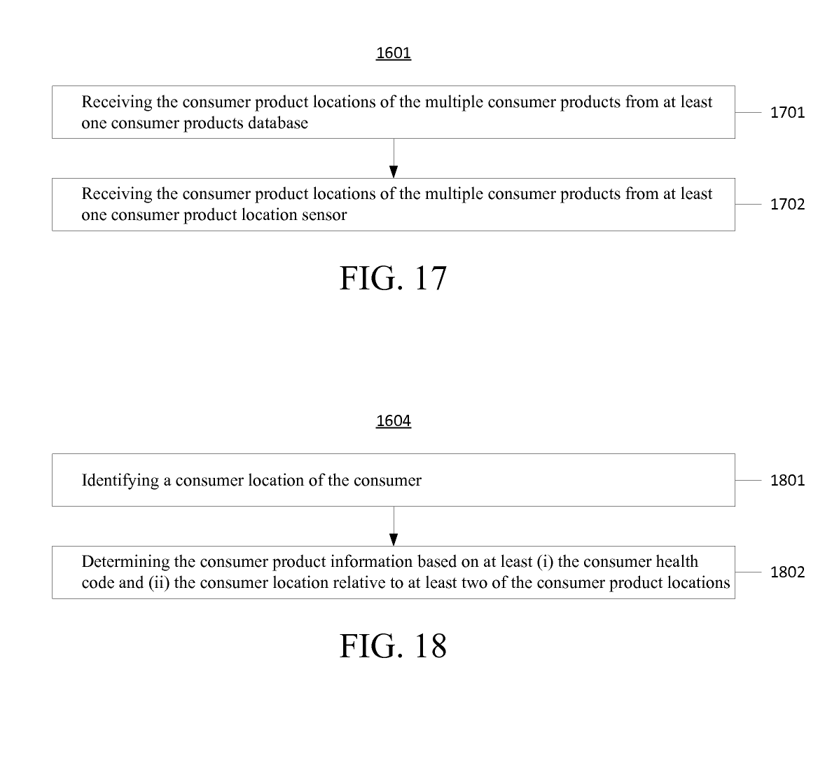

Method 1600 can comprise activity 1601 of identifying consumer product locations of multiple consumer products. In some embodiments, performing activity 1601 can be similar or identical to identifying consumer product locations of multiple consumer products as described above with respect to system 300 (FIG. 3) and/or location module 408 (FIG. 4). Further, the consumer product locations can be similar to the consumer product locations described above with respect to system 300 (FIG. 3); and/or the multiple consumer products can be similar or identical to the consumer products described above with respect to system 300 (FIG. 3). FIG. 17 illustrates an exemplary activity 1601, according to the embodiment of FIG. 16.

For example, activity 1601 can comprise activity 1701 of receiving the consumer product locations of the multiple consumer products from at least one consumer products database. In some embodiments, the consumer product database(s) can be similar or identical to consumer product database(s) 514 (FIG. 5).

Further, activity 1601 can comprise activity 1702 of receiving the consumer product locations of the multiple consumer products from at least one consumer product location sensor. In some embodiments, the consumer product location sensor(s) can be similar or identical to the consumer product location sensor(s) described above with respect to system 300 (FIG. 3) and/or location module 408 (FIG. 4). In some embodiments, when activity 1701 is performed, activity 1702 can be omitted, and vice versa.

Turning back to FIG. 16, method 1600 can comprise activity 1602 of determining a consumer health code based on health profile information of a consumer. In many embodiments, the health profile information of the consumer can be similar or identical to the health profile information of the consumer as described above with respect to system 300 (FIG. 3) and/or health module 407 (FIG. 4); the consumer health code can be similar or identical to the consumer health code described above with respect to system 300 (FIG. 3) and/or health module 407 (FIG. 4); and/or the consumer can be similar or identical to the consumer described above with respect to system 300 (FIG. 3). In some embodiments, performing activity 1602 can comprise an activity of further determining the consumer health code based on health profile information of a consumer affiliated entity of the consumer. In these embodiments, performing this activity can be similar or identical to determining the consumer health code based on health profile information of a consumer affiliated entity of the consumer as described above with respect to system 300 (FIG. 3) and/or information module 410 (FIG. 4). Meanwhile, in other embodiments, this activity can be omitted. Generally, the health profile information of the consumer affiliated entity can be similar or identical to the health profile information of the consumer affiliated entity as described above with respect to system 300 (FIG. 3) and/or health module 407 (FIG. 4); and/or the consumer affiliated entity can be similar or identical to the consumer affiliated entity described above with respect to system 300 (FIG. 3).

Further, in some embodiments, method 1600 can comprise activity 1603 of determining the consumer affiliated entity health code based on health profile information of the consumer affiliated entity of the consumer. In various embodiments, the consumer affiliated entity health code can be similar or identical to any of the consumer affiliated entity health code(s) described above with respect to system 300 (FIG. 3) and/or health module 407 (FIG. 4). In other embodiments, activity 1603 can be omitted.

Further, method 1600 can comprise activity 1604 of determining consumer product information to communicate to the consumer. In some embodiments, performing activity 1604 can be similar or identical to determining consumer product information to communicate to a consumer as described above with respect to system 300 (FIG. 3) and/or location module 408 (FIG. 4). Further, the consumer product information can be similar or identical to the consumer product information described above with respect to system 300 (FIG. 3). FIG. 18 illustrates an exemplary activity 1604, according to the embodiment of FIG. 16.

For example, activity 1604 can comprise activity 1801 of identifying a consumer location of the consumer. In these embodiments, performing activity 802 can be similar or identical to identifying a consumer location of the consumer as described above with respect to system 300 (FIG. 3) and/or location module 408 (FIG. 4). For example, in some embodiments, performing activity 1801 can comprise an activity of receiving the consumer location of the consumer from the consumer computer system. Further, the consumer computer system can be configured to detect the consumer location of the consumer, such as, for example, as described above with respect to system 300 (FIG. 3) and/or location module 408 (FIG. 4).

Also, activity 1604 can comprise activity 1802 of determining the consumer product information based on at least (i) the consumer health code and (ii) the consumer location relative to at least two of the consumer product locations. In many embodiments, performing activity 1802 can be similar or identical to determining the consumer product information based on at least (i) the consumer health code and (ii) the consumer location relative to at least two of the consumer product locations as described above with respect to system 300 (FIG. 3) and/or information module 410 (FIG. 4). In many embodiment, activity 1802 can be performed after activity 1801.

In some embodiments, when activity 1603 is performed, performing activity 1802 can comprise an activity of further determining the consumer product information based on the consumer affiliated entity health code. In these embodiments, performing this activity can be similar or identical to further determining the consumer product information based on the consumer affiliated entity health code as described above with respect to system 300 (FIG. 3) and/or information module 410 (FIG. 4). In other embodiments, this activity can be omitted, such as, for example, when activity 1603 is omitted.

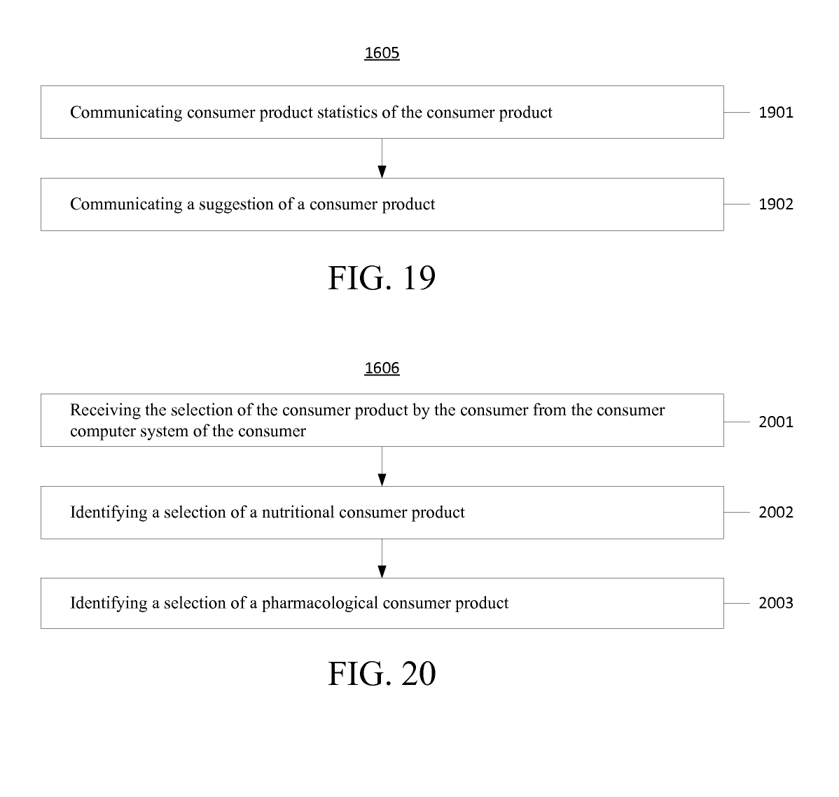

Referring now back to FIG. 16, method 1600 can comprise activity 1605 of communicating the consumer product information to the consumer. In many embodiments, performing activity 1605 can be similar or identical to communicating the consumer product information to the consumer as described above with respect to system 300 (FIG. 3). Generally, activity 1605 can be performed after one or more of activities 1601-1604. FIG. 19 illustrates an exemplary activity 1605, according to the embodiment of FIG. 16.

For example, activity 1605 can comprise activity 1901 of communicating consumer product statistics of the consumer product. In these embodiments, the consumer product information can include the consumer product statistics, and the consumer product statistics can be similar or identical to the consumer product statistics described above with respect to system 300 (FIG. 3) and/or information module 410 (FIG. 4).

Further, activity 1605 can comprise activity 1902 of communicating a suggestion of a consumer product. the consumer product information comprising the suggestion of the consumer product, and the multiple consumer products including the consumer product. In these embodiments, the consumer product information can include the suggestion of the consumer product, and the suggestion of the consumer product can be similar or identical to the suggestion of the consumer product described above with respect to system 300 (FIG. 3) and/or information module 410 (FIG. 4).

Meanwhile, referring again to FIG. 16, method 1600 can comprise activity 1606 of identifying a selection of a consumer product by the consumer. In these embodiments, the multiple consumer products can include the consumer product. Further, in these or other embodiments, performing activity 1606 can be similar or identical to identifying a selection of a consumer product by the consumer as described above with respect to system 300 (FIG. 3) and/or commerce module 409 (FIG. 4). FIG. 20 illustrates an exemplary activity 1606, according to the embodiment of FIG. 16.

For example, activity 1606 can comprise activity 2001 of receiving the selection of the consumer product by the consumer from a consumer computer system of the consumer. In many embodiments, the consumer computer system can be similar or identical to any of consumer computer system(s) 302 (FIG. 3) and/or to consumer computer system 303 (FIG. 3).

Further, activity 1606 can comprise activity 2002 of identifying a selection of a nutritional consumer product. In many embodiments, the nutritional consumer product can be similar or identical to the nutritional consumer product described above with respect to system 300 (FIG. 3) and/or commerce module 409 (FIG. 4). In some embodiments, activity 2002 can be performed as part of activity 2001.

Further still, activity 1606 can comprise activity 2003 of identifying a selection of a pharmacological consumer product. In many embodiments, the pharmacological consumer product can be similar or identical to the pharmacological consumer product described above with respect to system 300 (FIG. 3) and/or commerce module 409 (FIG. 4). In some embodiments, activity 2003 can be performed as part of activity 2001. In further embodiments, when activity 2002 is performed, activity 2003 can be omitted, and vice versa.

Returning again to FIG. 16, method 1600 can comprise activity 1607 of receiving a request from the consumer to have the consumer product information communicated to the consumer. In many embodiments, performing activity 1607 can be similar or identical to receiving a request from the consumer to have the consumer product information communicated to the consumer as described above with respect to system 300 (FIG. 3) and/or information module 410 (FIG. 4). In some embodiments, activity 1607 can be omitted. In many embodiments, activity 1607 can be performed before one or more of activities 1601-1606.

Further, method 1600 can comprise activity 1608 of receiving the health profile information of the consumer. In many embodiments, performing activity 1608 can comprise receiving the health profile information of the consumer as described above with respect to system 300 (FIG. 3) and/or health module 407 (FIG. 4). In many embodiments, activity 1608 can be performed before one or more of activities 1601-1607.

Also, method 1600 can comprise activity 1609 of prompting the consumer to provide the health profile information of the consumer. In many embodiments, performing activity 1609 can comprise prompting the consumer to provide the health profile information of the consumer as described above with respect to system 300 (FIG. 3) and/or health module 407 (FIG. 4). In some embodiments, activity 1609 can be performed prior to activity 1608. In other embodiments, activity 1609 can be omitted. In many embodiments, activity 1609 can be performed before one or more of activities 1601-1607.

In many embodiments, one or more of activities 1601 and 1604-1607 (and/or one or more sub-activities thereof) can be repeated one or more times for one or more other consumer products (e.g., a second consumer product). In some embodiments, the other consumer product(s) (e.g., the second consumer product) can comprise the suggested consumer product recommended at activity 1902 (FIG. 19). In further embodiments, one or more of activities 1602, 1603, 1608, and/or 1609 (and/or one or more sub-activities thereof) can be repeated one or more times, such as, for example, as the consumer updates the health profile information of the consumer and/or the one or more consumer affiliated entities.

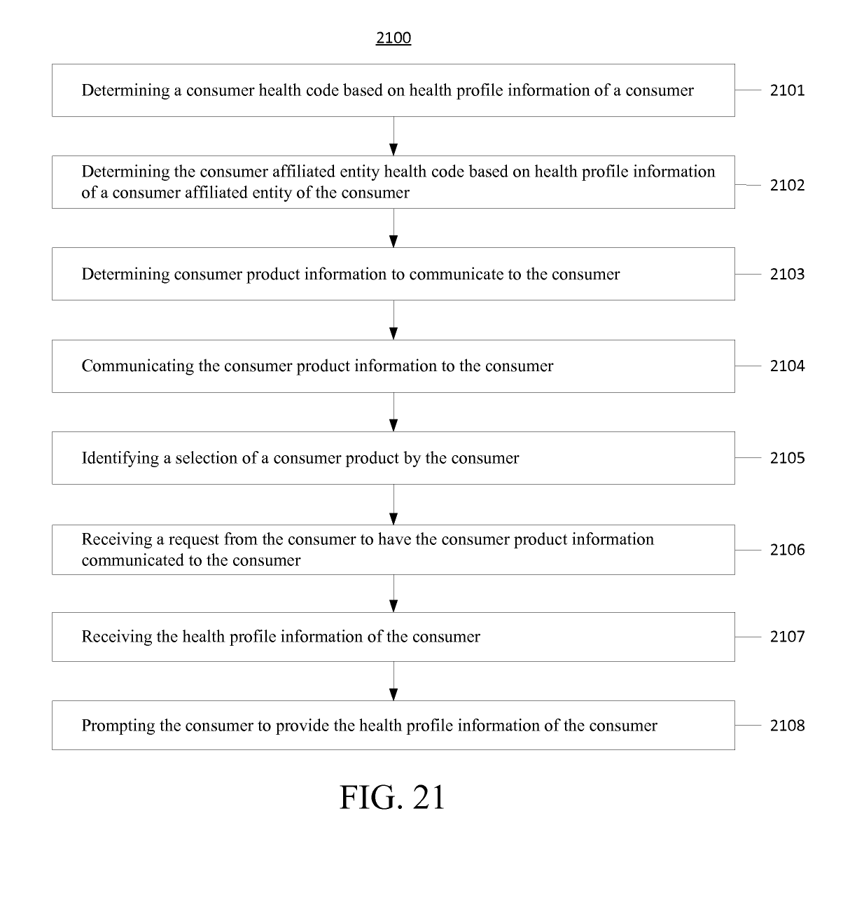

Turning ahead in the drawings, FIG. 21 illustrates a flow chart for a method 2100, according to an embodiment. Method 2100 is merely exemplary and is not limited to the embodiments presented herein. Method 2100 can be employed in many different embodiments or examples not specifically depicted or described herein. In some embodiments, the activities of method 2100 can be performed in the order presented. In other embodiments, the activities of method 2100 can be performed in any suitable order. In still other embodiments, one or more of the activities of method 2100 can be combined or skipped. In many embodiments, central computer system 301 (FIG. 3) can be suitable to perform method 2100 and/or one or more of the activities of method 2100. In these or other embodiments, one or more of the activities of method 2100 can be implemented as one or more computer instructions configured to run at one or more processing modules and configured to be stored at one or more non-transitory memory storage modules. The processing module(s) can be similar or identical to the processing module(s) described above with respect to computer system 100 (FIG. 1) and/or to processing module(s) 404 (FIG. 4). Further, the non-transitory memory storage module(s) can be similar or identical to the non-transitory memory storage module(s) described above with respect to computer system 100 (FIG. 1) and/or to non-transitory memory storage module(s) 406 (FIG. 4).

Method 2100 can comprise activity 2101 of determining a consumer health code based on health profile information of a consumer. In many embodiments, the health profile information of the consumer can be similar or identical to the health profile information of the consumer as described above with respect to system 300 (FIG. 3) and/or health module 407 (FIG. 4); the consumer health code can be similar or identical to the consumer health code described above with respect to system 300 (FIG. 3) and/or health module 407 (FIG. 4); and/or the consumer can be similar or identical to the consumer described above with respect to system 300 (FIG. 3). In some embodiments, performing activity 2101 can comprise an activity of further determining the consumer health code based on health profile information of a consumer affiliated entity of the consumer. In these embodiments, performing this activity can be similar or identical to determining the consumer health code based on health profile information of a consumer affiliated entity of the consumer as described above with respect to system 300 (FIG. 3) and/or information module 410 (FIG. 4). Meanwhile, in other embodiments, this activity can be omitted. Generally, the health profile information of the consumer affiliated entity can be similar or identical to the health profile information of the consumer affiliated entity as described above with respect to system 300 (FIG. 3) and/or health module 407 (FIG. 4); and/or the consumer affiliated entity can be similar or identical to the consumer affiliated entity described above with respect to system 300 (FIG. 3).

In some embodiments, method 2100 can comprise activity 2102 of determining the consumer affiliated entity health code based on health profile information of the consumer affiliated entity of the consumer. In various embodiments, the consumer affiliated entity health code can be similar or identical to any of the consumer affiliated entity health code(s) described above with respect to system 300 (FIG. 3) and/or health module 407 (FIG. 4). In other embodiments, activity 2102 can be omitted.

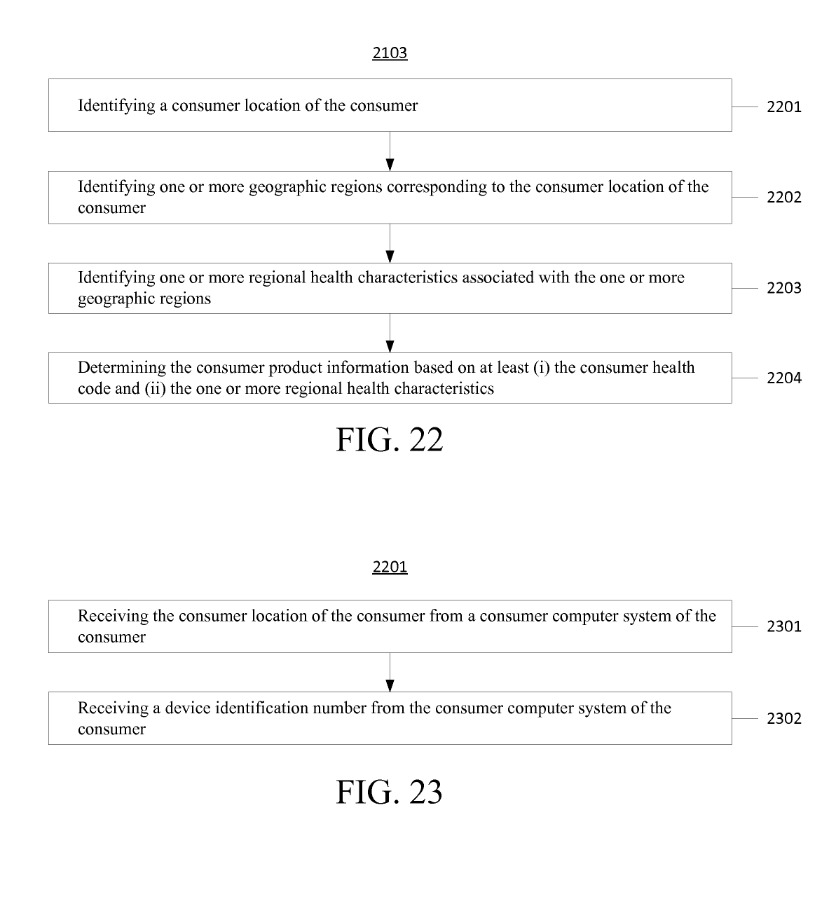

Further, method 2100 can comprise activity 2103 of determining consumer product information to communicate to the consumer. In some embodiments, performing activity 2103 can be similar or identical to determining consumer product information to communicate to a consumer as described above with respect to system 300 (FIG. 3) and/or location module 408 (FIG. 4). Further, the consumer product information can be similar or identical to the consumer product information described above with respect to system 300 (FIG. 3). FIG. 22 illustrates an exemplary activity 2103, according to the embodiment of FIG. 21. Also, communicating to the consumer can include communicating directly or indirectly to the consumer. For example, communicating indirectly to the consumer can include communicating the information to an electronic device of the consumer, where the electronic device of the consumer communicates the information directly to the consumer.

For example, activity 2103 can comprise activity 2201 of identifying a consumer location of the consumer. In these embodiments, performing activity 2103 can be similar or identical to identifying a consumer location of the consumer as described above with respect to system 300 (FIG. 3) and/or location module 408 (FIG. 4). FIG. 23 illustrates an exemplary activity 2201, according to the embodiment of FIG. 21.

For example, activity 2201 can comprise activity 2301 of receiving the consumer location of the consumer from a consumer computer system. Further, the consumer computer system can be configured to detect the consumer location of the consumer, such as, for example, as described above with respect to system 300 (FIG. 3) and/or location module 408 (FIG. 4).

Further, activity 2201 can comprise activity 2302 of receiving a device identification number from the consumer computer system of the consumer. The device identification number can be similar or identical to the device identification number described above with respect to system 300 (FIG. 3) and/or location module 408 (FIG. 4). In some embodiments, when activity 2301 is performed, activity 2302 can be omitted, and vice versa.

Returning again to FIG. 22, activity 2103 can comprise activity 2202 of identifying one or more geographic regions corresponding to the consumer location of the consumer. The geographic region(s) can be similar or identical to the geographic region(s) described above with respect to system 300 (FIG. 3) and/or location module 408 (FIG. 4). In some embodiments, performing activity 2202 can comprise an activity of receiving the geographic region(s) corresponding to the consumer location of the consumer from at least one geographic regions database. In these embodiments, the geographic regions database(s) can be similar or identical to geographical regions database(s) 515 (FIG. 5).

Further, activity 2103 can comprise activity 2203 of identifying one or more regional health characteristics associated with the one or more geographic regions. The regional health characteristic(s) can be similar or identical to the regional health characteristic(s) described above with respect to system 300 (FIG. 3) and/or location module 408 (FIG. 4). In some embodiments, performing activity 2203 can comprise an activity of receiving the regional health characteristic(s) associated with the geographic region(s) from at least one regional health characteristics database. In these embodiments, the regional health characteristics database(s) can be similar or identical to regional health characteristics database(s) 516 (FIG. 5).

Also, activity 2103 can comprise activity 2204 of determining the consumer product information based on at least (i) the consumer health code and (ii) the one or more regional health characteristics. In many embodiments, performing activity 1802 can be similar or identical to determining the consumer product information based on at least (i) the consumer health code and (ii) the one or more regional health characteristics as described above with respect to system 300 (FIG. 3) and/or information module 410 (FIG. 4). In many embodiment, activity 2204 can be performed after one or more of activities 2201-2203.

In some embodiments, when activity 2102 is performed, performing activity 2204 can comprise an activity of further determining the consumer product information based on the consumer affiliated entity health code. In these embodiments, performing this activity can be similar or identical to further determining the consumer product information based on the consumer affiliated entity health code as described above with respect to system 300 (FIG. 3) and/or information module 410 (FIG. 4). In other embodiments, this activity can be omitted, such as, for example, when activity 2102 is omitted.

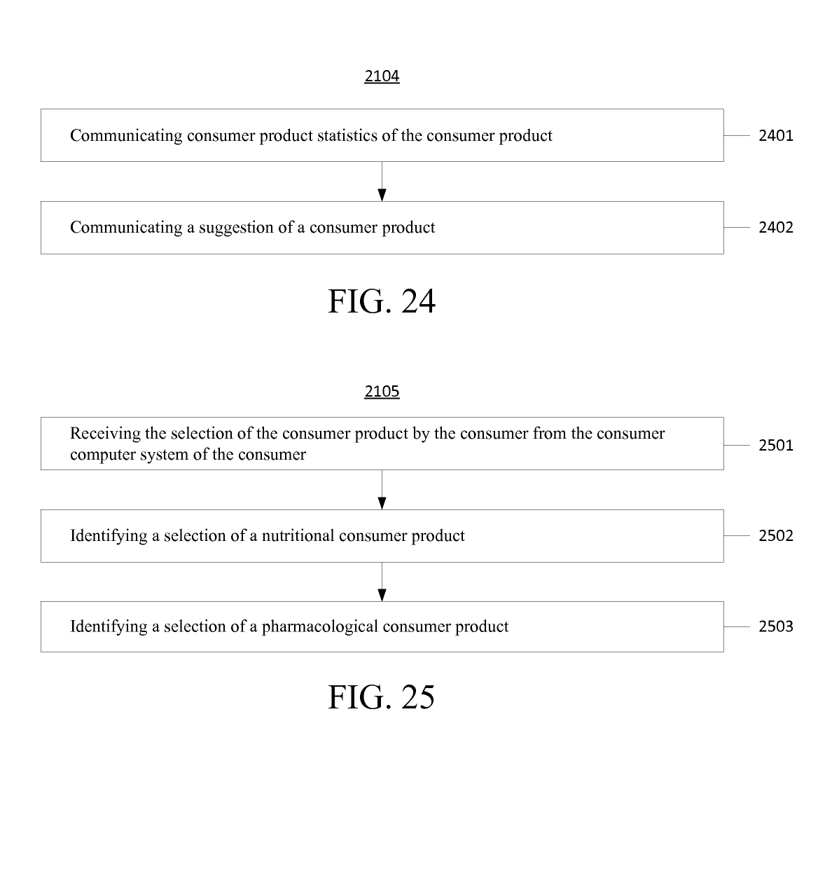

Referring now back to FIG. 21, method 2100 can comprise activity 2104 of communicating the consumer product information to the consumer. In many embodiments, performing activity 2104 can be similar or identical to communicating the consumer product information to the consumer as described above with respect to system 300 (FIG. 3). Generally, activity 2104 can be performed after one or more of activities 2101-2103. FIG. 24 illustrates an exemplary activity 2104, according to the embodiment of FIG. 21.

For example, activity 2104 can comprise activity 2401 of communicating consumer product statistics of the consumer product. In these embodiments, the consumer product information can include the consumer product statistics, and the consumer product statistics can be similar or identical to the consumer product statistics described above with respect to system 300 (FIG. 3) and/or information module 410 (FIG. 4).

Further, activity 2104 can comprise activity 2402 of communicating a suggestion of a consumer product. the consumer product information comprising the suggestion of the consumer product, and the multiple consumer products including the consumer product. In these embodiments, the consumer product information can include the suggestion of the consumer product, and the suggestion of the consumer product can be similar or identical to the suggestion of the consumer product described above with respect to system 300 (FIG. 3) and/or information module 410 (FIG. 4).

Meanwhile, referring again to FIG. 21, method 2100 can comprise activity 2105 of identifying a selection of a consumer product by the consumer. In these embodiments, the multiple consumer products can include the consumer product. Further, in these or other embodiments, performing activity 2105 can be similar or identical to identifying a selection of a consumer product by the consumer as described above with respect to system 300 (FIG. 3) and/or commerce module 409 (FIG. 4). FIG. 25 illustrates an exemplary activity 2105, according to the embodiment of FIG. 21.

For example, activity 2105 can comprise activity 2501 of receiving the selection of the consumer product by the consumer from a consumer computer system of the consumer. In many embodiments, the consumer computer system can be similar or identical to any of consumer computer system(s) 302 (FIG. 3) and/or to consumer computer system 303 (FIG. 3).

Further, activity 2105 can comprise activity 2502 of identifying a selection of a nutritional consumer product. In many embodiments, the nutritional consumer product can be similar or identical to the nutritional consumer product described above with respect to system 300 (FIG. 3) and/or commerce module 409 (FIG. 4). In some embodiments, activity 2502 can be performed as part of activity 2501.

Further still, activity 2105 can comprise activity 2503 of identifying a selection of a pharmacological consumer product. In many embodiments, the pharmacological consumer product can be similar or identical to the pharmacological consumer product described above with respect to system 300 (FIG. 3) and/or commerce module 409 (FIG. 4). In some embodiments, activity 2503 can be performed as part of activity 2501. In further embodiments, when activity 2502 is performed, activity 2503 can be omitted, and vice versa.

Returning again to FIG. 21, method 2100 can comprise activity 2106 of receiving a request from the consumer to have the consumer product information communicated to the consumer. In many embodiments, performing activity 2106 can be similar or identical to receiving a request from the consumer to have the consumer product information communicated to the consumer as described above with respect to system 300 (FIG. 3) and/or information module 410 (FIG. 4). In some embodiments, activity 2106 can be omitted. In many embodiments, activity 2106 can be performed before one or more of activities 2101-2105.

Further, method 2100 can comprise activity 2107 of receiving the health profile information of the consumer. In many embodiments, performing activity 2107 can comprise receiving the health profile information of the consumer as described above with respect to system 300 (FIG. 3) and/or health module 407 (FIG. 4). In many embodiments, activity 2107 can be performed before one or more of activities 2101-2106.

Also, method 2100 can comprise activity 2108 of prompting the consumer to provide the health profile information of the consumer. In many embodiments, performing activity 2108 can comprise prompting the consumer to provide the health profile information of the consumer as described above with respect to system 300 (FIG. 3) and/or health module 407 (FIG. 4). In some embodiments, activity 2108 can be performed prior to activity 2107. In other embodiments, activity 2108 can be omitted. In many embodiments, activity 2108 can be performed before one or more of activities 2101-2106.

In many embodiments, one or more of activities 2103-2106 (and/or one or more sub-activities thereof) can be repeated one or more times for one or more other consumer products (e.g., a second consumer product). In some embodiments, the other consumer product(s) (e.g., the second consumer product) can comprise the suggested consumer product recommended at activity 2402 (FIG. 24). In further embodiments, one or more of activities 2101, 2102, 2107, and/or 2108 (and/or one or more sub-activities thereof) can be repeated one or more times, such as, for example, as the consumer updates the health profile information of the consumer and/or the one or more consumer affiliated entities.

Although extending an existing product taxonomy has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-25 may be modified, and that the foregoing discussion of certain of these embodiments does not necessarily represent a complete description of all possible embodiments. For example, one or more of the activities of FIGS. 6-25 may include different activities and be performed by many different modules, in many different orders. As another example, the modules within central computer system 301 in FIG. 3 can be interchanged or otherwise modified.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A method comprising:
executing one or more first computer instructions configured to identify consumer product locations of multiple consumer products;
executing one or more second computer instructions configured to determine a consumer health code based on health profile information of a consumer;
executing one or more third computer instructions configured to determine consumer product information to communicate to the consumer, the executing the one or more third computer instructions comprising:
executing one or more fourth computer instructions configured to identify a consumer location of the consumer; and
executing one or more fifth computer instructions configured to determine the consumer product information based on at least (i) the consumer health code and (ii) the consumer location relative to at least two of the consumer product locations;
and
executing one or more sixth computer instructions configured to communicate to the consumer the consumer product information;
wherein:
the one or more first computer instructions, the one or more second computer instructions, the one or more third computer instructions, the one or more fourth computer instructions, the one or more fifth computer instructions, and the one or more sixth computer instructions are configured to run at one or more processing modules and configured to be stored at one or more non-transitory memory storage modules.

2) The method of claim 1 wherein:
executing the one or more fourth computer instructions comprises:
executing one or more seventh computer instructions configured to receive the consumer location of the consumer from a consumer computer system of the consumer, the consumer computer system being configured to detect the consumer location of the consumer.

3) The method of claim 1 wherein:
executing the one or more first computer instructions comprises one of:
executing one or more seventh computer instructions configured to receive the consumer product locations of the multiple consumer products from at least one consumer products database; or
executing one or more eighth computer instructions configured to receive the consumer product locations of the multiple consumer products from at least one consumer product location sensor.

4) The method of claim 1 wherein:
the health profile information of the consumer comprises at least one of (i) one or more physical characteristics of the consumer, (ii) one or more physical conditions of the consumer, or (iii) one or more medical prescriptions of the consumer.

5) The method of claim 1 wherein:
the health profile information of the consumer comprises at least one of an income of the consumer or an insurance coverage of the consumer.

6) The method of claim 1 further comprising:
executing one or more seventh computer instructions configured to determine a consumer affiliated entity health code based on health profile information of a consumer affiliated entity of the consumer;
wherein:
executing the one or more fifth computer instructions further comprises:
executing one or more eighth computer instructions configured to further determine the consumer product information based on the consumer affiliated entity health code;
and
the one or more seventh computer instructions are configured to run at the one or more processing modules and configured to be stored at the one or more non-transitory memory storage modules.

7) The method of claim 6 wherein:
the consumer affiliated entity of the consumer comprises one of a relative of the consumer or a pet of the consumer.

8) The method of claim 6 wherein:
the health profile information of the consumer affiliated entity comprises at least one of (i) one or more physical characteristics of the consumer affiliated entity, (ii) one or more physical conditions of the consumer affiliated entity, or (iii) one or more medical prescriptions of the consumer affiliated entity.

9) The method of claim 1 wherein:
executing the one or more second computer instructions further comprises:
executing one or more seventh computer instructions configured to further determine the consumer health code based on health profile information of a consumer affiliated entity of the consumer.

10) The method of claim 9 wherein:
the consumer affiliated entity of the consumer comprises one of a relative of the consumer or a pet of the consumer.

11) The method of claim 9 wherein:
the health profile information of the consumer affiliated entity comprises at least one of (i) one or more physical characteristics of the consumer affiliated entity, (ii) one or more physical conditions of the consumer affiliated entity, or (iii) one or more medical prescriptions of the consumer affiliated entity.

12) The method of claim 1 further comprising:
after executing the one or more sixth computer instructions, executing one or more seventh computer instructions configured to identify a selection of a consumer product by the consumer, the multiple consumer products including the consumer product;
wherein:
the one or more seventh computer instructions are configured to run at the one or more processing modules and configured to be stored at the one or more non-transitory memory storage modules.

13) The method of claim 12 wherein:
executing the one or more seventh computer instructions comprises at least one of:
executing one or more eighth computer instructions configured to identify a selection of a nutritional consumer product, the consumer product including the nutritional consumer product; or
executing one or more ninth computer instructions configured to identify a selection of a pharmacological consumer product, the consumer product including the pharmacological consumer product.

14) The method of claim 1 wherein:
executing the one or more sixth computer instructions comprises at least one of:
executing one or more seventh computer instructions configured to communicate consumer product statistics of a consumer product, the consumer product information including the consumer product statistics; or
executing one or more eighth computer instructions configured to communicate a suggestion of a consumer product, the consumer product information comprising the suggestion of the consumer product, and the multiple consumer products including the consumer product.

15) The method of claim 1 further comprising:
executing one or more seventh computer instructions configured to receive a request from the consumer to have the consumer product information communicated to the consumer;
wherein:
the one or more seventh computer instructions are configured to run at the one or more processing modules and configured to be stored at the one or more non-transitory memory storage modules.

16) The method of claim 1 further comprising:
executing one or more seventh computer instructions configured to receive the health profile information of the consumer; and
executing one or more eighth computer instructions configured to prompt the consumer to provide the health profile information of the consumer;
wherein:
the one or more seventh computer instructions and the one or more eighth computer instructions are configured to run at the one or more processing modules and configured to be stored at the one or more non-transitory memory storage modules.

17) A system comprising:
an input device;
a display device;
one or more processing modules; and
one or more non-transitory memory storage modules storing computer instructions configured to run on the one or more processing modules and perform the acts of:
identifying consumer product locations of multiple consumer products;
determining a consumer health code based on health profile information of a consumer;
determining consumer product information to communicate to a consumer, the determining the consumer product information to communicate to the consumer comprising:
identifying a consumer location of the consumer; and
determining the consumer product information based on at least (i) the consumer health code and (ii) the consumer location relative to at least two of the consumer product locations;
and
communicating to the consumer the consumer product information,
wherein:
the input device and the display device are configured to permit an operator of the one or more processing modules and the one or more non-transitory memory storage modules to manage the one or more processing modules and the one or more non-transitory memory storage modules.

18) The system of claim 17 wherein:
the health profile information of the consumer comprises at least one of (i) one or more physical characteristics of the consumer, (ii) one or more physical conditions of the consumer, or (iii) one or more medical prescriptions of the consumer.

19) At least one non-transitory memory storage module having computer instructions stored thereon executable by one or more processing modules to:
identify consumer product locations of multiple consumer products;
determine a consumer health code based on health profile information of a consumer;
determine consumer product information to communicate to a consumer by:
identifying a consumer location of the consumer; and
determining the consumer product information based on at least (i) the consumer health code and (ii) the consumer location relative to at least two of the consumer product locations;
and
communicate to the consumer the consumer product information.

20) The at least one non-transitory memory storage module of claim 19 wherein:
the health profile information of the consumer comprises at least one of (i) one or more physical characteristics of the consumer, (ii) one or more physical conditions of the consumer, or (iii) one or more medical prescriptions of the consumer; and
the health profile information of the consumer further comprises at least one of an income of the consumer or an insurance coverage of the consumer.
